(19) United States
(12) Patent Application Publication
(10) Pub. No.: US 2025/0239891 A1
(43) Pub. Date: Jul. 24, 2025

(54) SYSTEMS AND METHODS FOR DETECTING WIRELESS POWER RECEIVERS AND OTHER OBJECTS AT A NEAR-FIELD CHARGING PAD

(71) Applicant: Energous Corporation, San Jose, CA (US)

(72) Inventors: Cesar A. Johnston, Sunnyvale, CA (US); Deepak Jain, San Ramon, CA (US); Erik Heinke, San Jose, CA (US); Alister Hoss, Phoenix, AZ (US); Sean Nicolson, Irvine, CA (US)

(21) Appl. No.: 18/904,040

(22) Filed: Oct. 1, 2024

Related U.S. Application Data
(63) Continuation of application No. 18/326,991, filed on May 31, 2023, now Pat. No. 12,107,441.
Application No. 18/326,991 is a continuation of application No. 16/841,612, filed on Apr. 6, 2020, now Pat. No. 11,710,987.
Application No. 16/841,612 is a continuation of application No. 16/045,637, filed on Jul. 25, 2018, now Pat. No. 10,615,647.
Application No. 16/045,637 is a continuation of application No. 16/024,640, filed on Jun. 29, 2018, now abandoned.
(60) Provisional application No. 62/625,906, filed on Feb. 2, 2018.

(51) Int. Cl. H02J 50/60; H02J 50/05; H02J 50/20; H02J 50/40; H02J 50/80; H04B 5/70; H04B 17/21; H04B 17/24; H04B 17/29

(52) U.S. Cl. CPC H02J 50/60; H02J 50/05; H02J 50/20; H02J 50/80; H04B 5/70; H04B 17/21; H04B 17/24; H04B 17/29; H02J 50/402

(57) ABSTRACT

An example method is performed at a near-field charging pad with a processor, a power-transferring element, a signature-signal-receiving circuit, and the processor of the near-field charging pad is in communication with a data source that includes predefined signature signals that each identify one of (i) a wireless power receiver, (ii) an object other than a wireless power receiver, and (iii) a combination of a wireless power receiver and an object other than a wireless power receiver. The method includes: after sending a plurality of test radio frequency (RF) power transmission signals, detecting, using the signature-signal-receiving circuit, respective amounts of reflected power; generating, based on variations in the respective amounts of reflected power, a signature signal; and determining whether (i) an authorized wireless power receiver is present on the near-field charging pad and/or (ii) an object other than a wireless power receiver is present on the near-field charging pad.

### RELATED APPLICATIONS

This application is a continuation of U.S. patent application Ser. No. 18/326,991, filed May 31, 2023, entitled “Systems And Methods For Detecting Wireless Power Receivers And Other Objects At A Near-Field Charging Pad,” which is a continuation of U.S. patent application Ser. No. 16/841,612, filed Apr. 6, 2020 (now U.S. Pat. No. 11,710,987), entitled “Systems And Methods For Detecting Wireless Power Receivers And Other Objects At A Near-Field Charging Pad,” is a continuation of U.S. patent application Ser. No. 16/045,637, filed Jul. 25, 2018 (now U.S. Pat. No. 10,615,647), entitled “Systems And Methods For Detecting Wireless Power Receivers And Other Objects At A Near-Field Charging Pad,” which is a continuation of U.S. patent application Ser. No. 16/024,640, filed Jun. 29, 2018, entitled “Systems and Methods for Detecting Wireless Power Receivers and Other Objects at a Near-Field Charging Pad,” which claims priority to U.S. Provisional Application No. 62/625,906, filed Feb. 2, 2018, entitled “Systems and Methods for Detecting Wireless Power Receivers and Other Objects at a Near-Field Charging Pad,” all of which are hereby incorporated by reference in their entirety.

The present application is related to U.S. patents application Ser. Nos. 15/424,552, and 15/833,790, 15/943,559, 15/963,959, and to PCT Application No. PCT/US17/65886, and each of these related applications is hereby incorporated by reference in its respective entirety.

### TECHNICAL FIELD

The embodiments herein generally relate to antennas, software, and devices used in wireless power transmission systems and, more specifically, to a near-field charging pad that is able to detect wireless power receivers and other types of objects using a signature-signal receiving circuit.

### BACKGROUND

Conventional charging pads utilize induction to generate a magnetic field that is used to charge a device. Users have encountered numerous frustrating issues with these conventional charging pads, including having damage caused to objects that include magnetic strips and/or RFID chips (e.g., credits cards, security badges, passports, key fobs, and the like). Moreover, many of these conventional pads typically require placing the device to be charged at a specific position on the charging pad, and the device may not be moved to different positions on the pad, without interrupting or terminating the charging of the device. This results in a frustrating experience for many users as they may be unable to locate the device at the exact right position on the pad in which to start charging their device, and may further end up with damage to important objects that they use on a daily basis.

### SUMMARY

Accordingly, there is a need for wireless charging systems (e.g., radio frequency (RF) charging pads) that address the problems identified above. To this end, an RF charging pad is described herein that is capable of detecting whether an authorized wireless power receiver is located on the pad, and whether any other objects (which are not wireless power receivers) are located on the pad. Such systems and methods of use thereof help to discover presence of objects on the pad in order to determine whether to proceed with delivery of wireless power or whether to forgo transmitting wireless power in order to avoid potentially damaging any of the detected objects. The pad is also able to identify authorized wireless power receivers and/or ignore one or more wireless power receivers that are not authorized to be charged or powered by the RF charging pad and, thereby, avoid power leeching and other drains on the system as a whole, while ensuring that authorized wireless power receivers always receive power.

In some instances, the RF charging pad transmits test power transmission signals and then receives reflected power back from one or more wireless power receivers or from one or more objects (which are not wireless power receivers) that are present on the RF charging pad. The reflected power can be collected and analyzed to identify signature signals and to thereby determine whether an authorized device is present and/or also whether an object other than a wireless power receiver is present (as is explained in more detail below). In some embodiments, the process for reflecting power works even if an authorized wireless power receiver has no power remaining (e.g., its battery is completely drained), as the wireless power receiver is able to harness energy from the test power transmission signals to create impedance changes at the receiver side, which then cause different amounts of reflected power to be detected at the RF charging pad (and within different power-transfer zones thereof), thereby allowing the receiver to convey data to the RF charging pad.

As mentioned above, such systems and methods could further manage power transfer control communication between the RF charging pad and one or more wireless power receivers with or without any data-communication capability. In some instances, the wireless power receiver may comprise an electronic device, circuitry for receiving and converting wireless power transmission signals, and a data-communication radio, and the electronic device's battery may have no charge (or power) remaining, so the device is unable to send a data-communication signal to the pad. In this scenario, a different technique is needed to detect whether the wireless power receiver is authorized to receive wireless power or not. In other instances, the wireless power receiver may comprise an electronic device and circuitry for receiving and converting wireless power transmission signals, and may not include any data-communication radio, and thus a technique is needed to be able to determine whether such receivers are authorized to receive wireless power from the pad. The various embodiments discussed herein provide techniques that solve these problems.

In the description that follows, references are made to an RF charging pad that includes various antenna zones. For the purposes of this description, power-transfer (or antenna) zones include one or more power-transferring elements (e.g., antennas such as a capacitive coupler) of the RF charging pad, and each power-transfer zone may be individually addressable by a controlling integrated circuit (e.g., RF power transmitter integrated circuit 160, FIGS. 1A-1B) to allow for selective activation of each power-transfer zone in order to determine which power-transfer zone is able to most efficiently transfer wireless power to a receiver. The RF charging pad is also inter-changeably referred to herein as a near-field charging pad, or, more simply, as a charging pad.

(A1) In some embodiments, a method is performed at a near-field charging pad that includes a wireless communication component (e.g., communication component 204, FIG. 1A), a plurality of power-transfer zones that each respectively include at least one power-transferring element (e.g., example power-transfer zones are shown in FIG. 1B) and a signature-signal receiving circuit (e.g., circuit 240, FIG. 3A), and one or more processors (e.g., CPU 202, FIGS. 1B and 2A). The method includes: sending, by a respective power-transferring element included in a first power-transfer zone of the plurality of power-transfer zones, a plurality of test power transmission signals with first values for a first set of transmission characteristics. The method also includes: in conjunction with sending each of the plurality of test power transmission signals, detecting, using the signature-signal receiving circuit, respective amounts of reflected power at the first power-transfer zone. The method further includes: based at least in part on the respective amounts of reflected power, determining whether (i) an authorized wireless power receiver and/or (ii) an object other than a wireless power receiver is present on a surface of the near-field charging pad that is adjacent to the first power-transfer zone.

(A2) In some embodiments of the method of A1, the detecting the respective amounts of reflected power at the first power-transfer zone includes determining, using the signature-signal receiving circuit, one or more signature signals that are based at least in part on the respective amounts of reflected power at the first power-transfer zone. The method also further includes: determining, based on a comparison of the one or more signature signals with one or more predefined signature signals, that an authorized wireless power receiver is present on the surface of the near-field charging pad that is adjacent to the first antenna zone. In some embodiments, the authorized wireless power receiver includes a signature-signal generating circuit that uses power harvested from the plurality of test power transmission signals to generate the one or more signature signals; and in accordance with the determining that the authorized wireless power receiver is present on the surface, transmitting, by the respective power-transferring element included in the first antenna zone, additional power transmission signals with second values for the first set of transmission characteristics. In some embodiments, the signature-signal receiving circuit is configured to detect measurements of reflected power at the first antenna zone and these measurements may change based on presence or absence of objects on a surface adjacent to the first antenna zone (e.g., a surface of the pad that is immediately above the first antenna zone). Additionally, the signature-signal generating circuit may be configured to cause impedance changes at the wireless power receiving, which allows for the generation of different signature signals by the signature-signal generating circuit and, thereby, to cause the receipt of the different signature signals at the signature-signal receiving circuit of the first antenna zone. As discussed in more detail below, this allows for creating of a scheme in which authorized wireless power receivers may be detected based on the different signature signals, and un-authorized wireless power receivers may be ignored, to avoid allowing unauthorized devices to leach power from the system.

(A3) In some embodiments of the method of A2, the determining that the authorized wireless power receiver is present on the surface also includes determining, based on the comparison of the one or more signature signals with the one or more predefined signature signals that an object other than a wireless power receiver is present between the authorized wireless power receiver and the surface. The method additional includes: determining that the near-field charging pad is configured to send power transmission signals while an object other than a wireless power receiver is present on the near-field charging pad; and after determining that the near-field charging pad is configured to send power transmission signals while an object other than a wireless power receiver is present on the near-field charging pad, sending the additional power transmission signals.

(A4) In some embodiments of the method of A2, the one or more signature signals are conveyed to the signature-signal receiving circuit of the first power-transfer zone by encoding the one or more signature signals using manipulations to an impedance value of the wireless power receiver, the manipulations to the impedance value causing the amounts of reflected power to vary at different points in time. In some embodiments, the manipulations to the impedance value cause the signature-signal receiving circuit to detect variations in the measurements of reflected power and these variations may be decoded to produce the one or more signature signals (e.g., example decoded signature signals are shown in FIG. 4). In some embodiments, the one or more signature signals comprise a combination of frequency and duty cycle values. In some embodiments, in addition to conveying information regarding whether a wireless power receiver is authorized to receive power from the pad, the one or more signature signals may also be used to convey data to the pad. Examples as to how data may be encoded using the signature signals are shown in FIG. 4.

(A5) In some embodiments of the method of any one of A1-A4, the near-field charging pad includes a data-communication radio, and the sending of the plurality of test power transmission signals is performed without receiving any signal via the data-communication radio.

(A6) In some embodiments of the method of A5, the sending of the plurality of test power transmission signals is performed upon expiration of a predefined time period (e.g., once every second, every two seconds, or every five seconds).

(A7) In some embodiments of the method of any one of A1-A5, the method further includes: in conjunction with the sending of the plurality of test power transmission signals, sending a respective plurality of test power transmission signals by respective power-transferring elements included in each power-transfer zone of the plurality of power-transfer zones; detecting, using respective signature-signal receiving circuits included in each respective power-transfer zone of the plurality of power-transfer zones, respective amounts of reflected power at each of the plurality of power-transfer zones; and determining, for each power-transfer zone of the plurality of power-transfer zones, whether (a) a wireless power receiver and/or (ii) an object other than a wireless power receiver is present at a respective surface adjacent to each of the plurality of power-transfer zones. In other words, each of the power-transfer zones is configured to send the test power transmission signals and to then determine whether any authorized wireless power receiver and/or object is present over that power-transfer zone.

(A8) In some embodiments of the method of A7, the method further includes: based on the respective amounts of reflected power detected at a second power-transfer zone of the plurality of power-transfer zones, determining that an object other than a wireless power receiver is present at the second power-transfer zone; and in accordance with determining that the object other than a wireless power receiver is present at the second power-transfer zone, determining whether the near-field charging pad is configured to transmit wireless power while one or more objects are present on the near-field charging pad. In some embodiments, the sending of the additional power transmission signals is only performed after determining that the near-field charging pad is configured to send wireless power while one or more objects are present on the near-field charging pad. In some embodiments, the near-field charging pad is configured with a parameter that indicates whether it is allowed to send power while foreign objects (e.g., objects other than wireless power receivers) are present on the pad. For instance, an owner or operator of the pad may set this parameter during a setup procedure for the pad. In some embodiments, the classifying may also be performed in a more granular fashion, e.g., to determine types of objects that are not wireless power receivers (e.g., metallic objects, non-metallic objects, credit cards, spilled liquids, etc.).

(A9) In some embodiments of the method of A2 or A3, the one or more processors of the near-field charging pad are in communication with a data source (e.g., an internal or external database) that includes the one or more predefined signature signals.

(A10) In some embodiments of the method of A9, the data source is populated with the one or more predefined signature signals during a configuration process in which each of a plurality of different wireless power receivers is placed on the near-field charging pad to allow the near-field charging pad to detect and then store a respective predefined signature signal for each of the plurality of different wireless power receivers.

(A11) In some embodiments of the method of A10, the configuration process also includes placing a plurality of different objects, which are not wireless power receivers, on the near-field charging pad to allow the near-field charging pad to detect and then store a respective predefined signature signal for each of the plurality of different objects. In some embodiments, during this configuration process, identifiers for each of the different objects are also stored with each of the respective stored signature signals, thereby allowing the near-field charging pad to identify different types of objects based on matching a signature signal to one of the stored signals.

(A12) In some embodiments of the method of any one of A1-A11, the method further includes: after sending the additional power transmission signals, receiving a data-communication signal from the wireless power receiver, the data-communication signal including information that allows the near-field charging pad to determine device-specific values for the first set of transmission characteristics; and in response to receiving the data-communication signal, ceasing to send the additional power transmission signals and instead sending, via the respective power-transfer element included in the first power-transfer zone, further power transmission signals with the device-specific values for the first set of transmission characteristics. In instances in which the wireless power receiver is a device that does not include any data-communication radio, these operations are not performed and instead the pad continues to transmit the additional power transmission signals until a determination is made that the wireless power receiver is fully charged (e.g., the signature-signal generating circuit at the wireless power receiver may be used to generate a signal that conveys to the signature-signal receiving circuit of the first antenna zone that the receiver has reached a fully charged state) or that the wireless power receiver is no longer present on the pad.

(A13) In some embodiments of the method of any one of A1-A12, the first and second values for the first set of transmission characteristics are the same.

(A14) In some embodiments of the method of any one of A1-A13, the first and second values for the first set of transmission characteristics are different.

(A15) In some embodiments of the method of any one of A1-A14, the wireless power receiver comprises a power-receiving element and a rectifier coupled to the power-receiving element for converting alternating current generated by receipt of power transmission signals to direct current (DC), and the signal-generating circuit of the wireless power receiver includes: impedance-modification circuitry positioned at a direct current (DC) output port of the rectifier, the impedance-modification circuitry configured to modify an impedance at the wireless power receiver.

(A16) In some embodiments of the method of any one of A1-A15, the signature-signal receiving circuit comprises the circuitry described above in reference to FIG. 3G.

(A17) In some embodiments of the method of any one of A1-A16, the power-transferring element is a near-field capacitive coupler, and the near-field capacitive coupler comprises a metal layer having a primary coupler and one or more parasitic coupling elements adjacent to the primary coupler on the metal layer.

(A18) In some embodiments of the method of any one of A1-A17, the near-field capacitive coupler is coupled with a power amplifier via a transmission line, the transmission line configured to provide the plurality of test power transmission signals and the additional power transmission signals to the near-field capacitive coupler.

(A19) In some embodiments of the method of any one of A1-A18, the transmission line is coupled with the signature-signal receiving circuit.

(A20) In another aspect, a near-field charging pad is provided. In some embodiments, the near-field charging pad includes a wireless communication component, a plurality of antenna zones that each respectively include at least one antenna element and a signature-signal receiving circuit, one or more processors, and memory storing one or more programs, which when executed by the one or more processors cause the near-field charging pad to perform the method described in any one of A1-A19.

(A21) In yet another aspect, a near-field charging pad is provided and the near-field charging includes means for performing the method described in any one of A1-A19.

(A22) In still another aspect, a non-transitory computer-readable storage medium is provided. The non-transitory computer-readable storage medium stores executable instructions that, when executed by a near-field charging pad (that includes a wireless communication component, a plurality of antenna zones that each respectively include at least one antenna element and a signature-signal receiving circuit) with one or more processors/cores, cause the near-field charging pad to perform the method described in any one of A1-A19.

Thus, wireless charging systems configured in accordance with the principles described herein are able to one or more operations including (1) identifying an authorized electronic device, (2) discovering any foreign object between the RF charging pad and the wireless power receivers, and/or (3) managing power transfer control communication between the RF charging pad and wireless power receivers with or without any data-communication capability, thereby providing numerous improvements and resolving numerous problems and limitations of conventional charging pads.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not intended to circumscribe or limit the inventive subject matter.

### BRIEF DESCRIPTION OF THE DRAWINGS

So that the present disclosure can be understood in greater detail, a more particular description may be had by reference to the features of various embodiments, some of which are illustrated in the appended drawings. The patent or application file contains at least one drawing executed in color. Copies of this patent or patent application publication with color drawing(s) will be provided by the Office upon request and payment of the necessary fee. The appended drawings, however, merely illustrate pertinent features of the present disclosure and are therefore not to be considered limiting, for the description may admit to other effective features.

FIG. 1A is a block diagram of an RF wireless power transmission system, in accordance with some embodiments.

FIG. 1B is a block diagram showing components of an example RF charging pad that includes an RF power transmitter integrated circuit and antenna zones, in accordance with some embodiments.

FIG. 1C is a block diagram showing components of an example RF charging pad that includes an RF power transmitter integrated circuit coupled to a switch, in accordance with some embodiments.

FIG. 2A is a block diagram illustrating an example RF charging pad, in accordance with some embodiments.

FIG. 2B is a block diagram illustrating an example receiver device, in accordance with some embodiments.

FIG. 3A is a block diagram of simplified circuits of an example wireless transmitter located at a RF charging pad and an example wireless receiver located at a receiver device in accordance with some embodiments.

FIGS. 3B-1 and 3B-2 show block diagrams illustrating circuits including a rectifier coupled to a variable load of a wireless receiver located at a receiver device in accordance with some embodiments.

FIG. 3C is a block diagram illustrating circuits including a reflect switch within a wireless receiver located at a receiver device in accordance with some embodiments.

FIG. 3D is a block diagram illustrating an example of a signature-signal generating circuit located at a receiver device in accordance with some embodiments.

FIG. 3E illustrates a block diagram illustrating an example transmitter circuit including a signature-signal receiving circuit located at a charging pad in accordance with some embodiments.

FIGS. 3F-3H show respective block diagrams illustrating various example circuits of wireless transmitters and wireless receivers in accordance with some embodiments.

FIG. 4 lists example messages encoded with signature signals in PFM/PWM pairs in accordance with some embodiments.

FIG. 5A illustrates a simplified diagram showing a highly-coupled near-field capacitive coupler that is used in a wireless power transmitter in accordance with some embodiments.

FIG. 5B shows a plurality of efficiency maps corresponding to various embodiments when the receiver is placed over different regions of a transmitter in accordance with some embodiments.

FIG. 6A is a flow diagram showing a process of detecting a receiver by sending beacon signals periodically in accordance with some embodiments.

FIG. 6B is a flow diagram showing a process of optional training performed by a transmitter in accordance with some embodiments.

FIG. 7 is a flow diagram showing a process of collecting, storing, and analyzing ADC samples performed by a transmitter in accordance with some embodiments.

FIG. 8A is a flow diagram showing a process of analyzing ADC samples performed by a transmitter in accordance with some embodiments.

FIG. 8B is a flow diagram showing a process of evaluating zone status to determine whether there is a foreign object and/or a receiver in accordance with some embodiments.

FIGS. 9A-9B are flow diagrams showing a method of operating a near-field charging pad, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

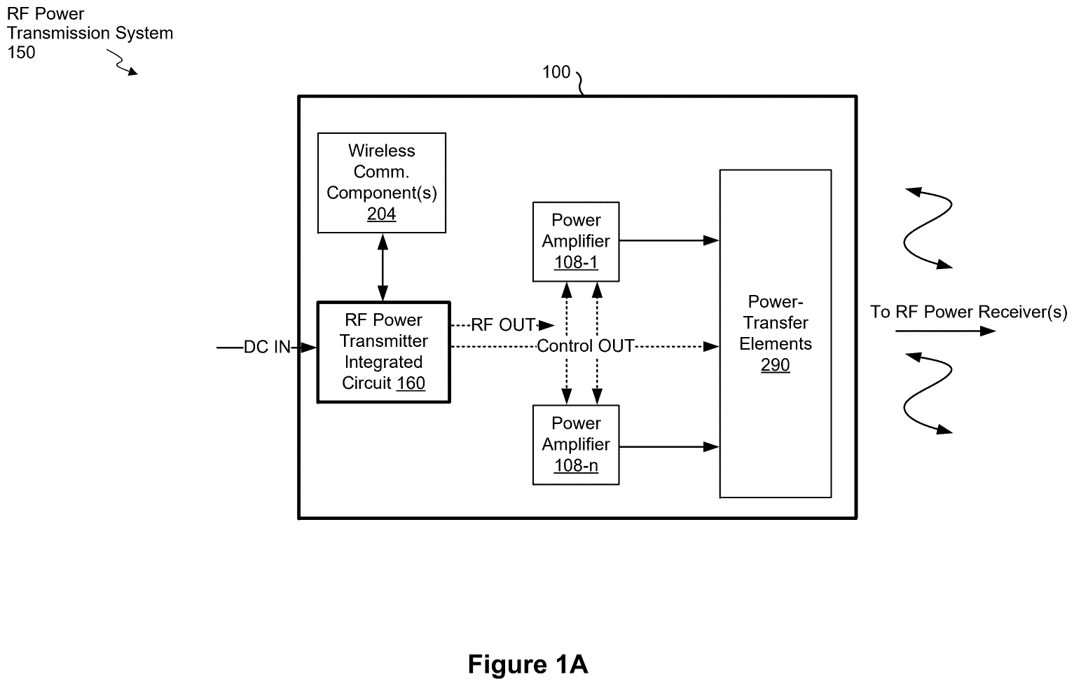

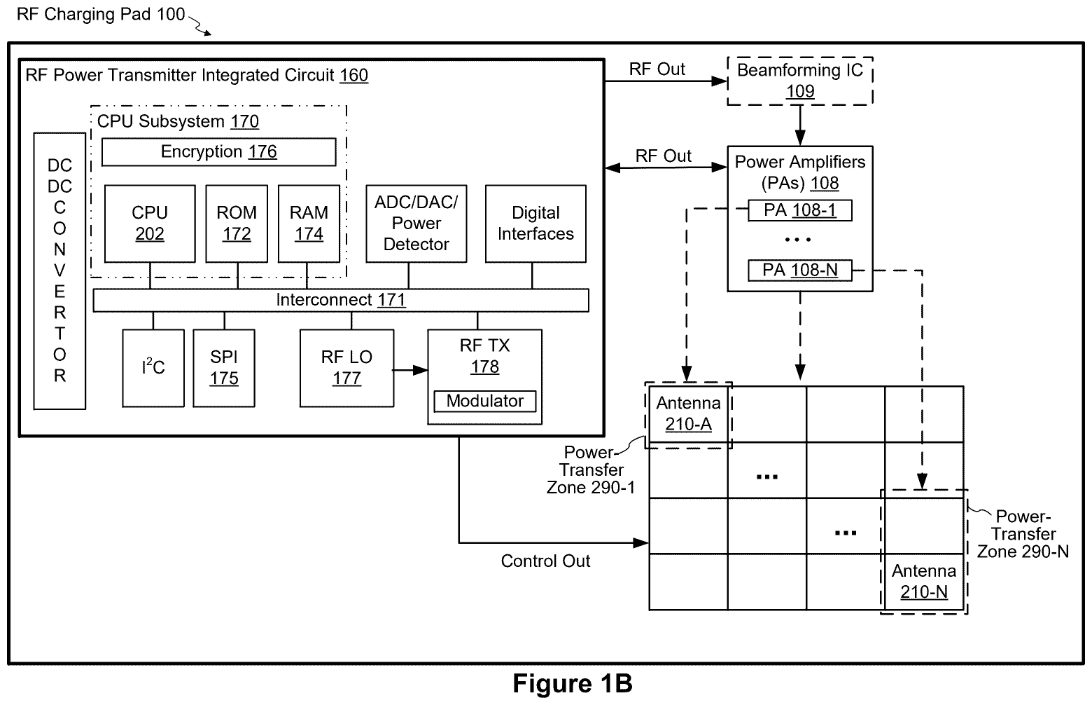

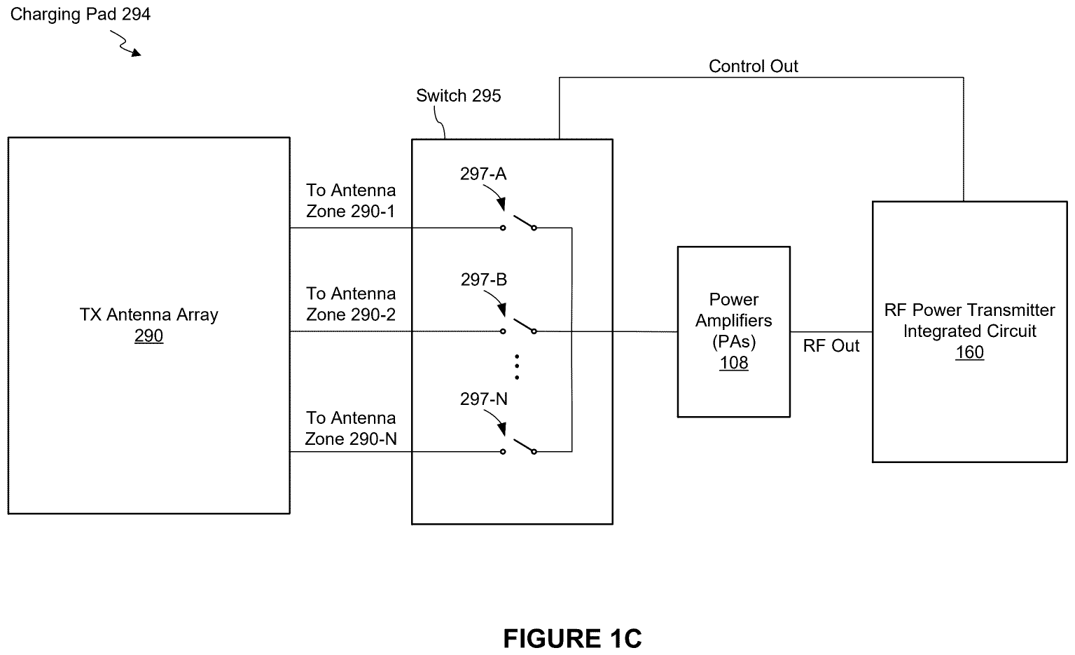

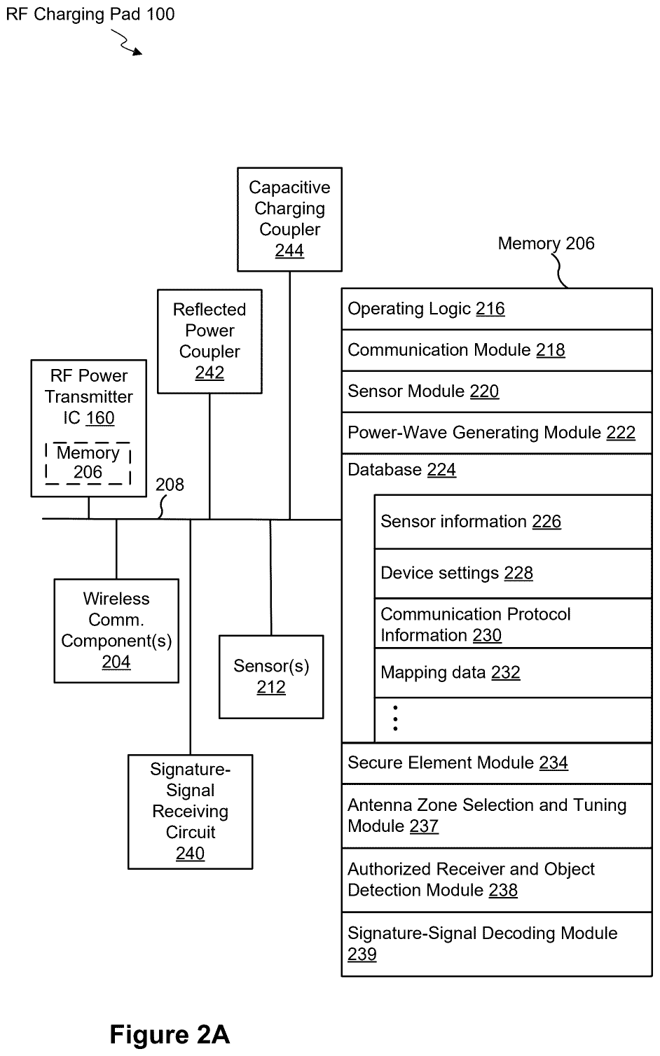

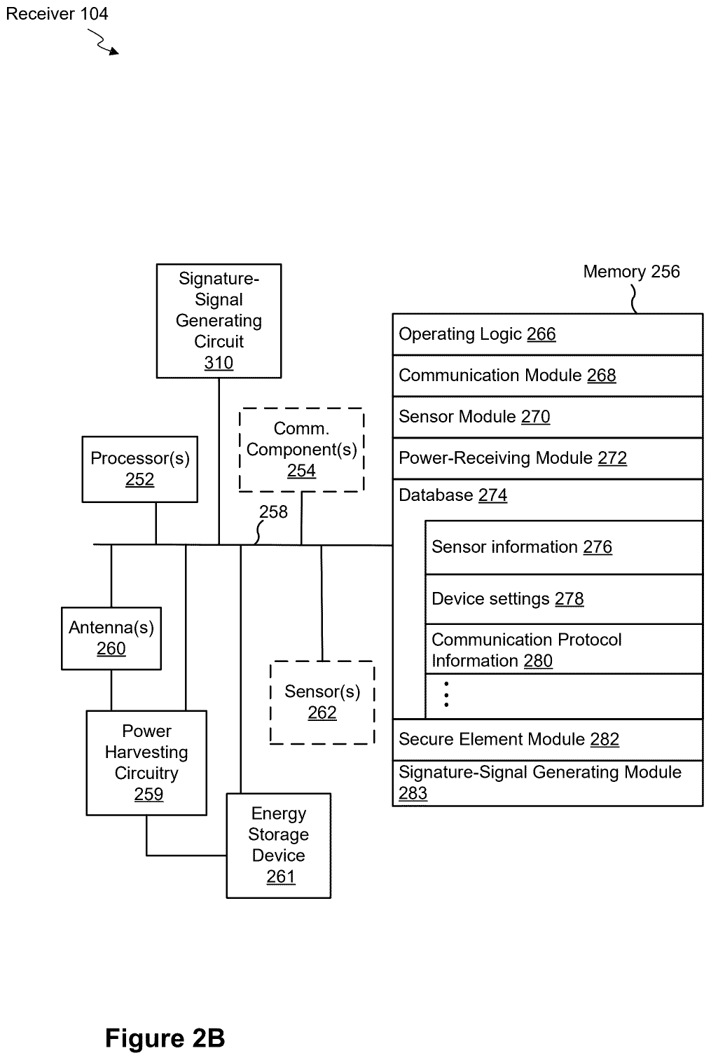

FIG. 1A is a block diagram of an RF wireless power transmission system 150 in accordance with some embodiments. In some embodiments, the RF wireless power transmission system 150 includes a RF charging pad 100 (also referred to herein as a near-field (NF) charging pad 100 or RF charging pad 100). In some embodiments, the RF charging pad 100 includes an RF power transmitter integrated circuit 160 (described in more detail below). In some embodiments, the RF charging pad 100 includes one or more communications components 204 (e.g., wireless communication components, such as WI-FI or BLUETOOTH radios), discussed in more detail below with reference to FIG. 2A. In some embodiments, the RF charging pad 100 also connects to one or more power amplifier units 108-1, . . . 108-n to control operation of the one or more power amplifier units when they drive external power-transfer elements (e.g., power-transfer elements 290). In some embodiments, RF power is controlled and modulated at the RF charging pad 100 via switch circuitry as to enable the RF wireless power transmission system to send RF power to one or more wireless receiving devices via the TX antenna array 210.

In some embodiments, the communication component(s) 204 enable communication between the RF charging pad 100 and one or more communication networks. In some embodiments, the communication component(s) 204 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document.

In some instances, the communication component(s) 204 are not able to communicate with wireless power receivers for various reasons, e.g., because there is no power available for the communication component(s) to use for the transmission of data signals or because the wireless power receiver itself does not actually include any communication component of its own. As such, it is important to design near-field charging pads that are still able to uniquely identify different types of devices and, when a wireless power receiver is detected, figure out if that wireless power receiver is authorized to receive wireless power.

FIG. 1B is a block diagram of the RF power transmitter integrated circuit 160 (the “integrated circuit”) in accordance with some embodiments. In some embodiments, the integrated circuit 160 includes a CPU subsystem 170, an external device control interface, an RF subsection for DC to RF power conversion, and analog and digital control interfaces interconnected via an interconnection component, such as a bus or interconnection fabric block 171. In some embodiments, the CPU subsystem 170 includes a microprocessor unit (CPU) 202 with related Read-Only-Memory (ROM) 172 for device program booting via a digital control interface, e.g. an I²C port, to an external FLASH containing the CPU executable code to be loaded into the CPU Subsystem Random Access Memory (RAM) 174 (e.g., memory 206, FIG. 2A) or executed directly from FLASH. In some embodiments, the CPU subsystem 170 also includes an encryption module or block 176 to authenticate and secure communication exchanges with external devices, such as wireless power receivers that attempt to receive wirelessly delivered power from the RF charging pad 100.

In some embodiments, executable instructions running on the CPU (such as those shown in the memory 206 in FIG. 2A and described below) are used to manage operation of the RF charging pad 100 and to control external devices through a control interface, e.g., SPI control interface 175, and the other analog and digital interfaces included in the RF power transmitter integrated circuit 160. In some embodiments, the CPU subsystem also manages operation of the RF subsection of the RF power transmitter integrated circuit 160, which includes an RF local oscillator (LO) 177 and an RF transmitter (TX) 178. In some embodiments, the RF LO 177 is adjusted based on instructions from the CPU subsystem 170 and is thereby set to different desired frequencies of operation, while the RF TX converts, amplifies, modulates the RF output as desired to generate a viable RF power level.

In the descriptions that follow, various references are made to antenna zones and power-transfer zones, which terms are used synonymously in this disclosure. In some embodiments the antenna/power-transfer zones may include antenna elements that transmit propagating radio frequency waves but, in other embodiments, the antenna/power transfer zones may instead include capacitive charging couplers that convey electrical signals but do not send propagating radio frequency waves.

In some embodiments, the RF power transmitter integrated circuit 160 provides the viable RF power level (e.g., via the RF TX 178) to an optional beamforming integrated circuit (IC) 109, which then provides phase-shifted signals to one or more power amplifiers 108. In some embodiments, the beamforming IC 109 is used to ensure that power transmission signals sent using two or more antennas 210 (e.g., each antenna 210 may be associated with a different antenna zone 290 or may each belong to a single antenna zone 290) to a particular wireless power receiver are transmitted with appropriate characteristics (e.g., phases) to ensure that power transmitted to the particular wireless power receiver is maximized (e.g., the power transmission signals arrive in phase at the particular wireless power receiver). In some embodiments, the beamforming IC 109 forms part of the RF power transmitter IC 160. In embodiments in which capacitive couplers (e.g., capacitive charging couplers 244) are used as the antennas 210, then optional beamforming IC 109 may not be included in the RF power transmitter integrated circuit 160.

In some embodiments, the RF power transmitter integrated circuit 160 provides the viable RF power level (e.g., via the RF TX 178) directly to the one or more power amplifiers 108 and does not use the beamforming IC 109 (or bypasses the beamforming IC if phase-shifting is not required, such as when only a single antenna 210 is used to transmit power transmission signals to a wireless power receiver).

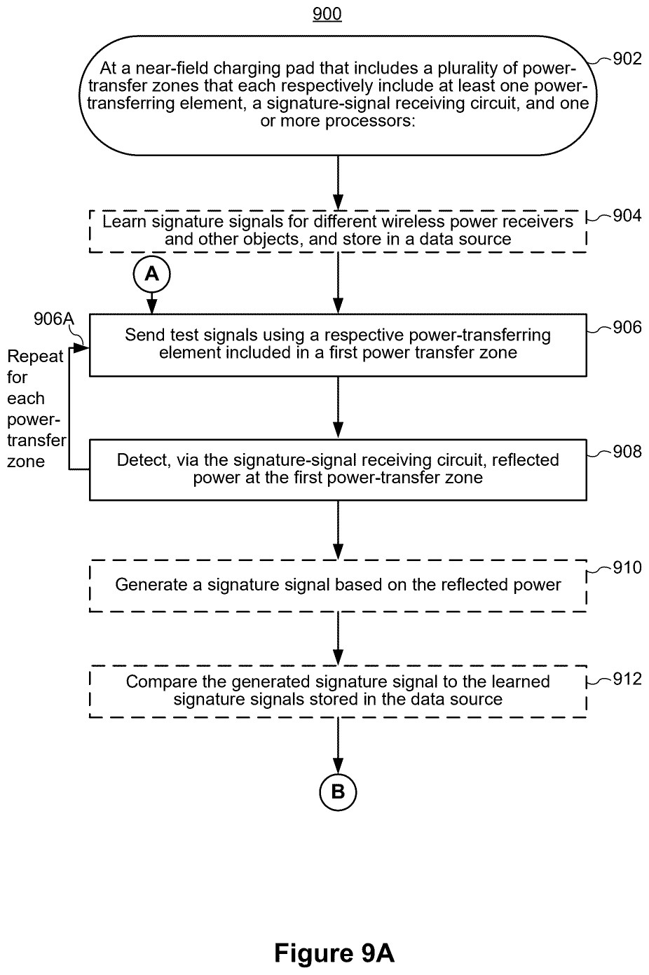

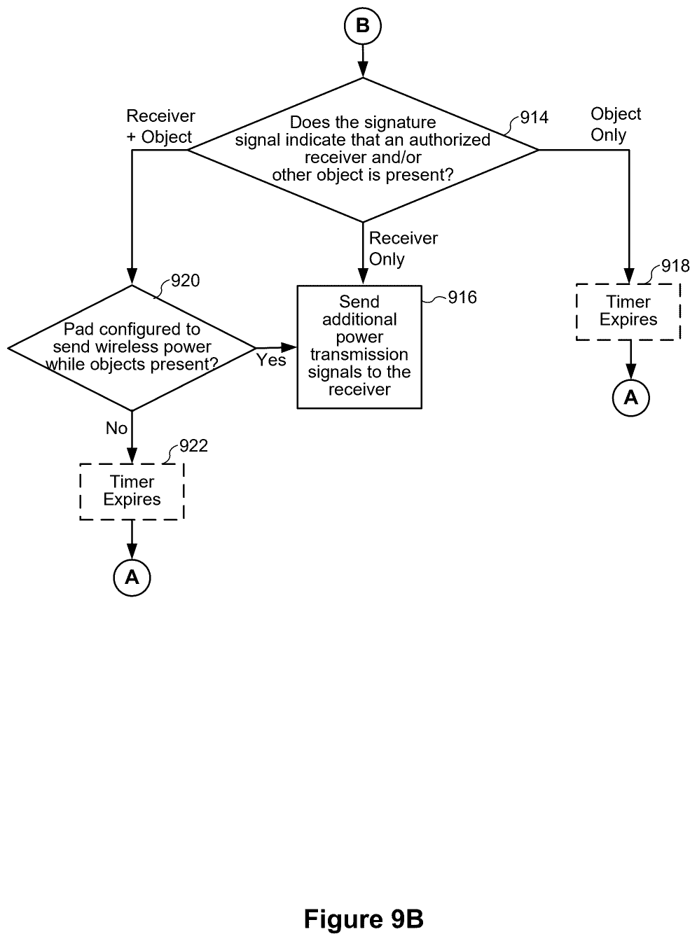

In some embodiments, the one or more power amplifiers 108 then provide RF signals to the antenna zones 290 (also referred to herein as “power-transfer zones”) for transmission to wireless power receivers that are authorized to receive wirelessly delivered power from the RF charging pad 100. In some embodiments, each antenna zone 290 is coupled with a respective PA 108 (e.g., antenna zone 290-1 is coupled with PA 108-1 and antenna zone 290-N is coupled with PA 108-N). In some embodiments, multiple antenna zones are each coupled with a same set of PAs 108 (e.g., all PAs 108 are coupled with each antenna zone 290). Various arrangements and couplings of PAs 108 to antenna zones 290 allow the RF charging pad 100 to sequentially or selectively activate different antenna zones in order to determine the most efficient antenna zone 290 to use for transmitting wireless power to a wireless power receiver (as explained in more detail below in reference to FIGS. 9A-9B, 10, and 11A-11E). In some embodiments, the one or more power amplifiers 108 are also in communication with the CPU subsystem 170 to allow the CPU 202 to measure output power provided by the PAs 108 to the antenna zones of the RF charging pad 100.

FIG. 1B also shows that, in some embodiments, the antenna zones 290 of the RF charging pad 100 may include one or more antennas 210A-N. In some embodiments, each antenna zones of the plurality of antenna zones includes one or more antennas 210 (e.g., antenna zone 290-1 includes one antenna 210-A and antenna zones 290-N includes multiple antennas 210). In some embodiments, a number of antennas included in each of the antenna zones is dynamically defined based on various parameters, such as a location of a wireless power receiver on the RF charging pad 100. In some embodiments, the antenna zones may include one or more of the meandering line antennas described in more detail below. In some embodiments, each antenna zone 290 may include antennas of different types (e.g., a meandering line antenna and a loop antenna), while in other embodiments each antenna zone 290 may include a single antenna of a same type (e.g., all antenna zones 290 include one meandering line antenna), while in still other embodiments, the antennas zones may include some antenna zones that include a single antenna of a same type and some antenna zones that include antennas of different types. In some embodiments the antenna/power-transfer zones may also or alternatively include capacitive charging couplers that convey electrical signals but do not send propagating radio frequency waves. Antenna zones are also described in further detail below.

In some embodiments, the RF charging pad 100 may also include a temperature monitoring circuit that is in communication with the CPU subsystem 170 to ensure that the RF charging pad 100 remains within an acceptable temperature range. For example, if a determination is made that the RF charging pad 100 has reached a threshold temperature, then operation of the RF charging pad 100 may be temporarily suspended until the RF charging pad 100 falls below the threshold temperature.

By including the components shown for RF power transmitter circuit 160 (FIG. 1B) on a single chip, such transmitter chips are able to manage operations at the transmitter chips more efficiently and quickly (and with lower latency), thereby helping to improve user satisfaction with the charging pads that are managed by these transmitter chips. For example, the RF power transmitter circuit 160 is cheaper to construct, has a smaller physical footprint, and is simpler to install. Furthermore, and as explained in more detail below in reference to FIG. 2A, the RF power transmitter circuit 160 may also include a secure element module 234 (e.g., included in the encryption block 176 shown in FIG. 1B) that is used in conjunction with a secure element module 282 (FIG. 2B) or a receiver 104 to ensure that only authorized receivers are able to receive wirelessly delivered power from the RF charging pad 100 (FIG. 1B).

FIG. 1C is a block diagram of a charging pad 294 in accordance with some embodiments. The charging pad 294 is an example of the charging pad 100 (FIG. 1A), however, one or more components included in the charging pad 100 are not included in the charging pad 294 for ease of discussion and illustration.

The charging pad 294 includes an RF power transmitter integrated circuit 160, one or more power amplifiers 108, and a transmitter antenna array 290 having multiple antenna zones. Each of these components is described in detail above with reference to FIGS. 1A and 1B. Additionally, the charging pad 294 includes a switch 295 (i.e., transmitter-side switch), positioned between the power amplifiers 108 and the antenna array 290, having a plurality of switches 297-A, 297-B, . . . 297-N. The switch 295 is configured to switchably connect one or more power amplifiers 108 with one or more antenna zones of the antenna array 290 in response to control signals provided by the RF power transmitter integrated circuit 160.

To accomplish the above, each switch 297 is coupled with (e.g., provides a signal pathway to) a different antenna zone of the antenna array 290. For example, switch 297-A may be coupled with a first antenna zone 290-1 (FIG. 1B) of the antenna array 290, switch 297-B may be coupled with a second antenna zone 290-2 of the antenna array 290, and so on. Each of the plurality of switches 297-A, 297-B, . . . 297-N, once closed, creates a unique pathway between a respective power amplifier 108 (or multiple power amplifiers 108) and a respective antenna zone of the antenna array 290. Each unique pathway through the switch 295 is used to selectively provide RF signals to specific antenna zones of the antenna array 290. It is noted that two or more of the plurality of switches 297-A, 297-B, . . . 297-N may be closed at the same time, thereby creating multiple unique pathways to the antenna array 290 that may be used simultaneously.

In some embodiments, the RF power transmitter integrated circuit 160 is coupled to the switch 295 and is configured to control operation of the plurality of switches 297-A, 297-B, . . . 297-N (illustrated as a “control out” signal in FIGS. 1A and 1C). For example, the RF power transmitter integrated circuit 160 may close a first switch 297-A while keeping the other switches open. In another example, the RF power transmitter integrated circuit 160 may close a first switch 297-A and a second switch 297-B, and keep the other switches open (various other combinations and configuration are possible). Moreover, the RF power transmitter integrated circuit 160 is coupled to the one or more power amplifiers 108 and is configured to generate a suitable RF signal (e.g., the “RF Out” signal) and provide the RF signal to the one or more power amplifiers 108. The one or more power amplifiers 108, in turn, are configured to provide the RF signal to one or more antenna zones of the antenna array 290 via the switch 295, depending on which switches 297 in the switch 295 are closed by the RF power transmitter integrated circuit 160.

To further illustrate, as described in some embodiments below, the charging pad is configured to transmit test power transmission signals and/or regular power transmission signals using different antenna zones, e.g., depending on a location of a receiver on the charging pad. Accordingly, when a particular antenna zone is selected for transmitting test signals or regular power signals, a control signal is sent to the switch 295 from the RF power transmitter integrated circuit 160 to cause at least one switch 297 to close. In doing so, an RF signal from at least one power amplifier 108 can be provided to the particular antenna zone using a unique pathway created by the now-closed at least one switch 297.

In some embodiments, the switch 295 may be part of (e.g., internal to) the antenna array 290. Alternatively, in some embodiments, the switch 295 is separate from the antenna array 290 (e.g., the switch 295 may be a distinct component, or may be part of another component, such as the power amplifier(s) 108). It is noted that any switch design capable of accomplishing the above may be used, and the design of the switch 295 illustrated in FIG. 1C is merely one example.

FIG. 2A is a block diagram illustrating certain components of an RF charging pad 100 in accordance with some embodiments. In some embodiments, the RF charging pad 100 includes an RF power transmitter IC 160 (and the components included therein, such as those described above in reference to FIGS. 1A-1B), memory 206 (which may be included as part of the RF power transmitter IC 160, such as nonvolatile memory 206 that is part of the CPU subsystem 170), and one or more communication buses 208 for interconnecting these components (sometimes called a chipset). In some embodiments, the RF charging pad 100 includes one or more sensor(s) 212 (discussed below). In some embodiments, the RF charging pad 100 includes one or more output devices such as one or more indicator lights, a sound card, a speaker, a small display for displaying textual information and error codes, etc. In some embodiments, the RF charging pad 100 includes a location detection device, such as a GPS (global positioning satellite) or other geo-location receiver, for determining the location of the RF charging pad 100.

In some embodiments, the one or more sensor(s) 212 include one or more thermal radiation sensors, ambient temperature sensors, humidity sensors, IR sensors, occupancy sensors (e.g., RFID sensors), ambient light sensors, motion detectors, accelerometers, and/or gyroscopes.

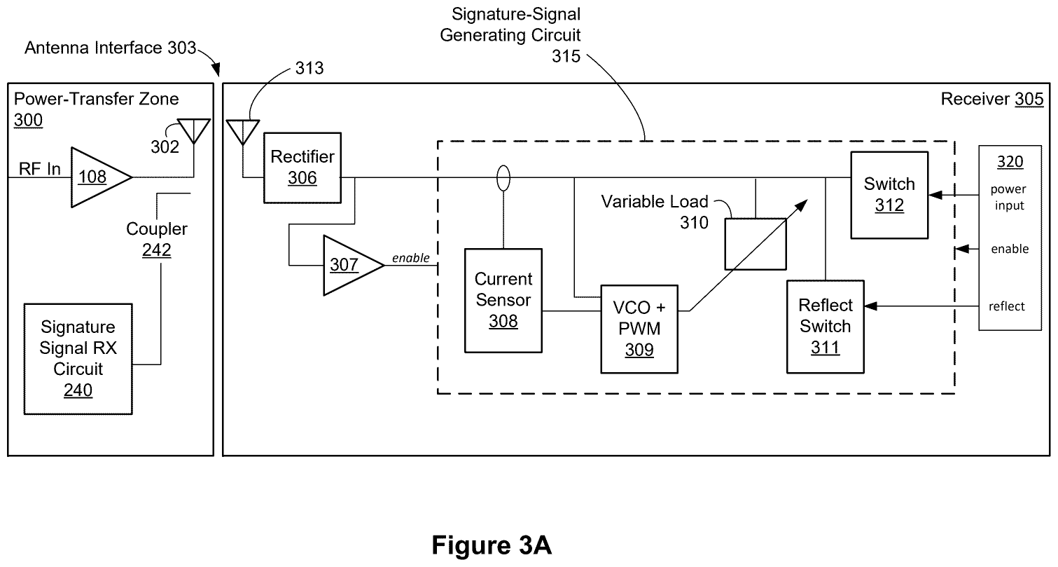

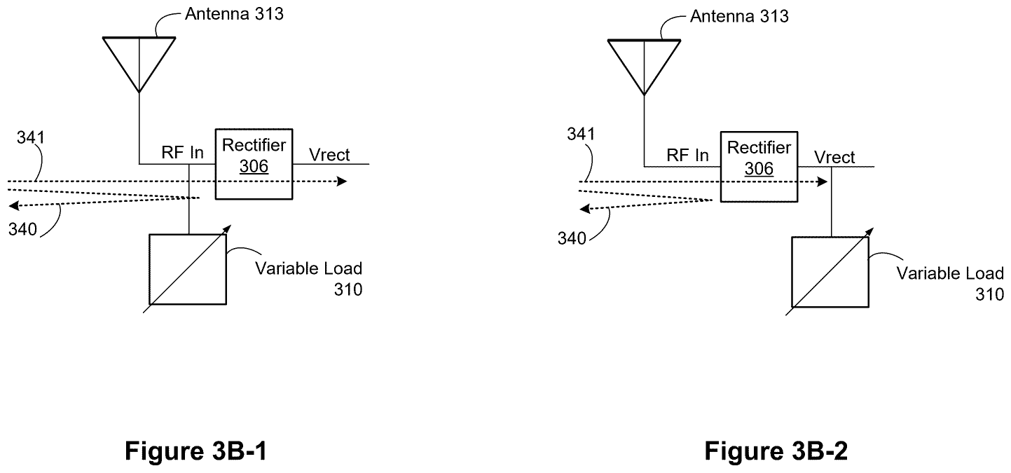

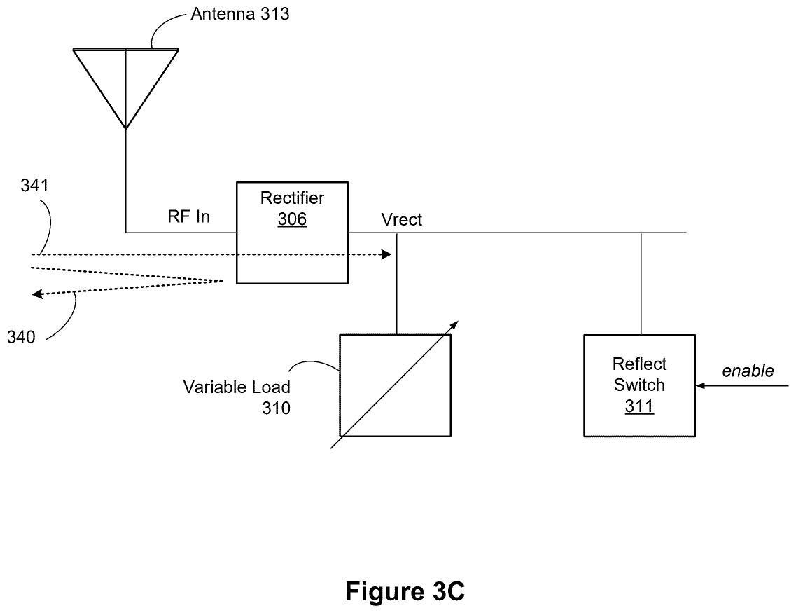

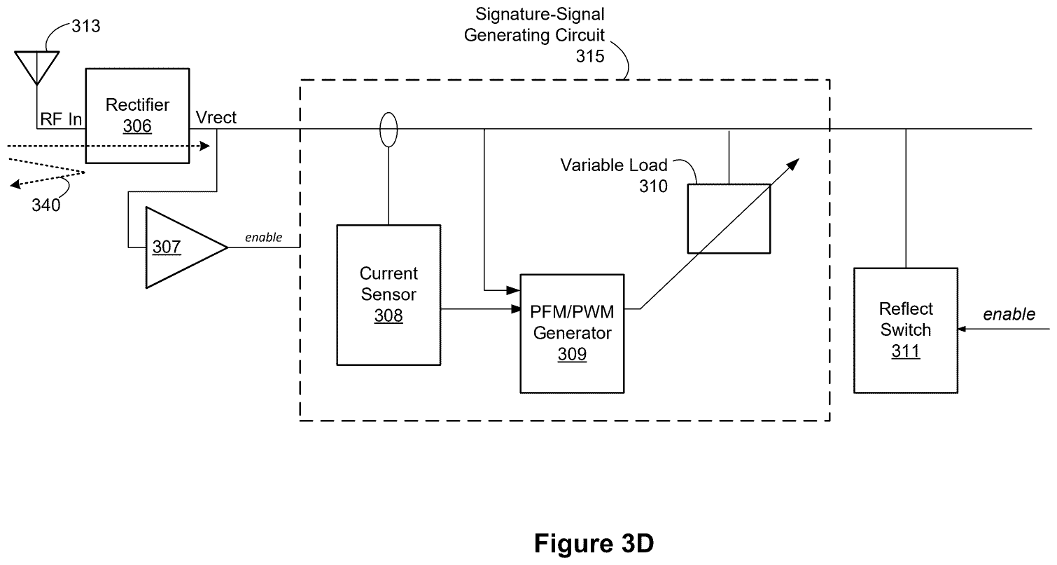

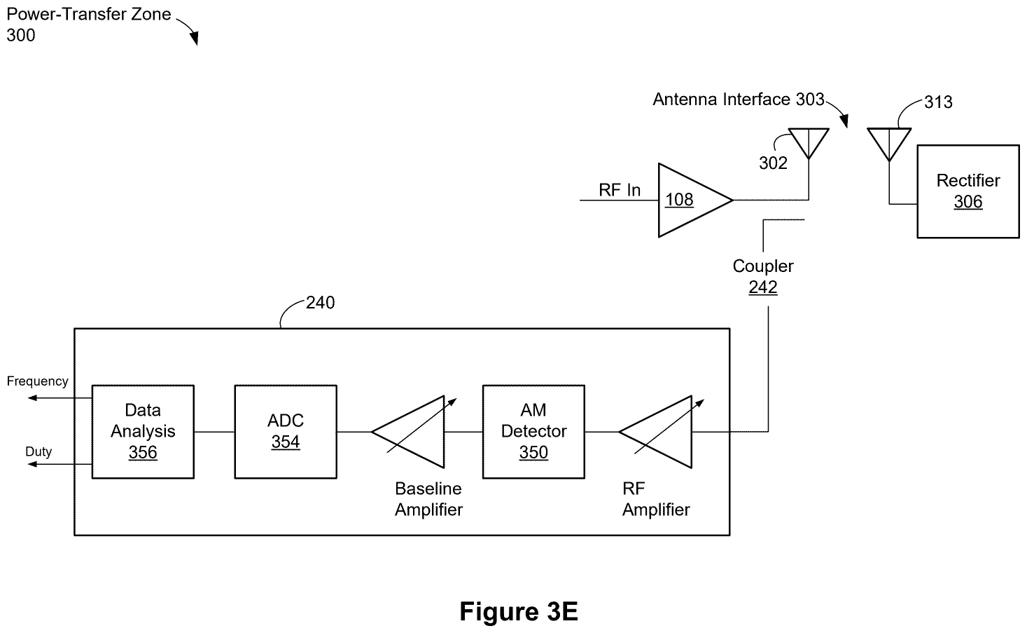

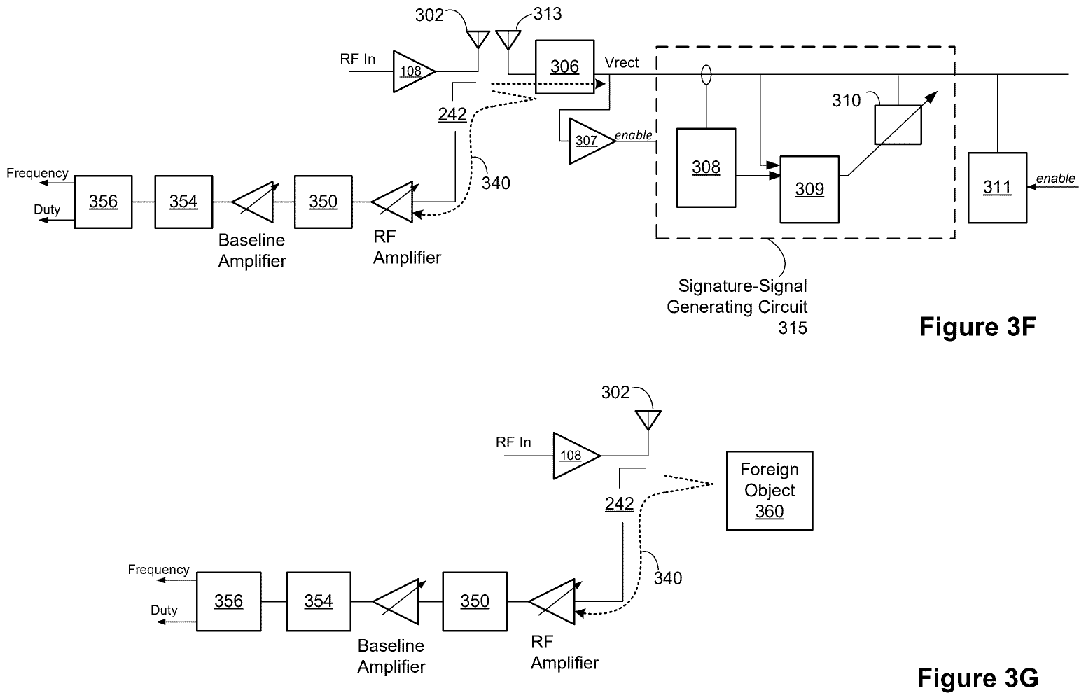

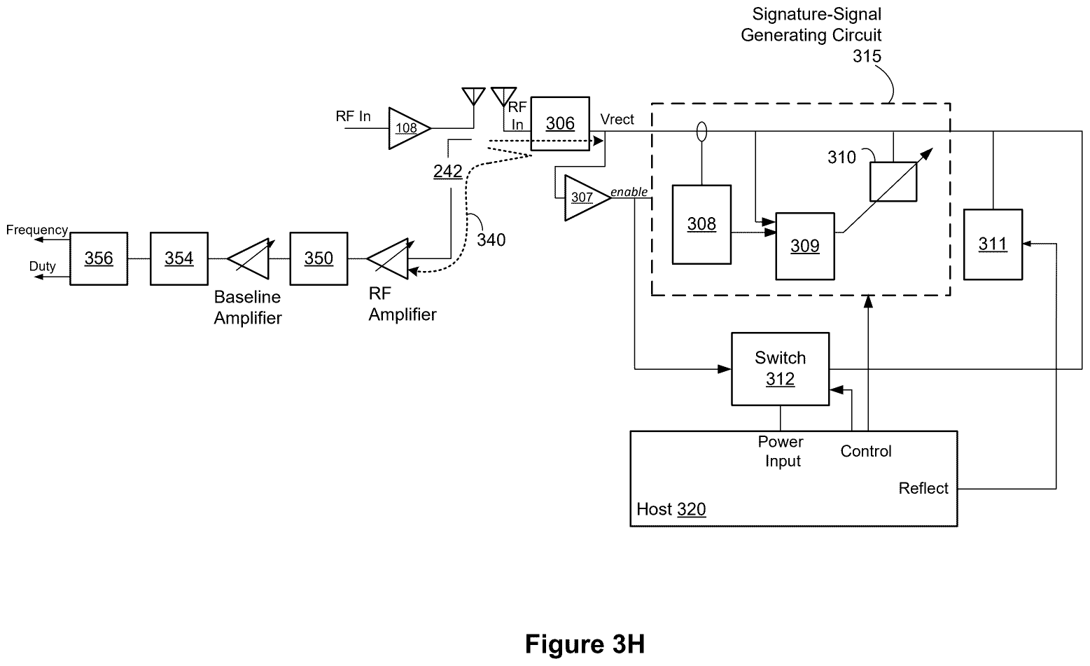

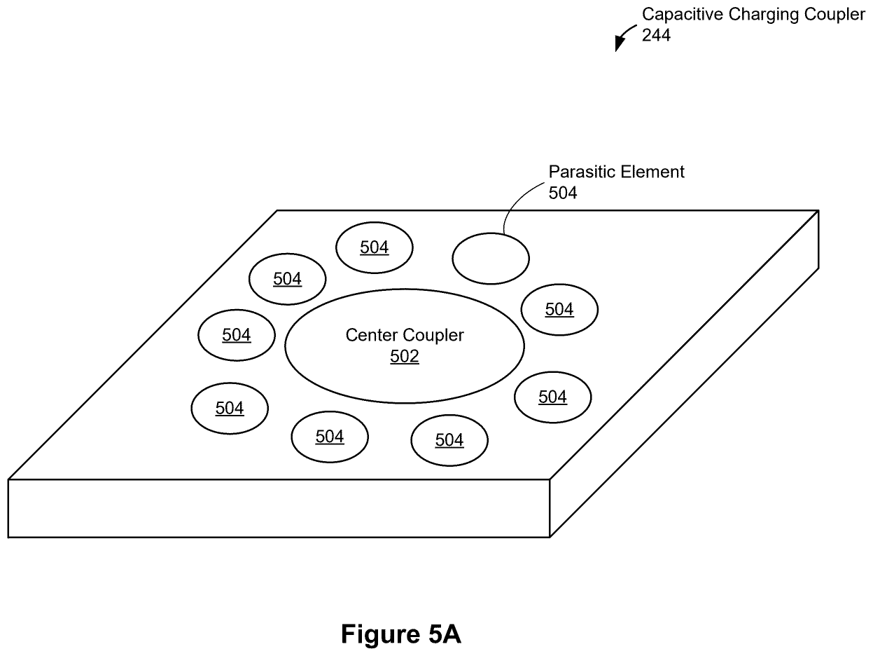

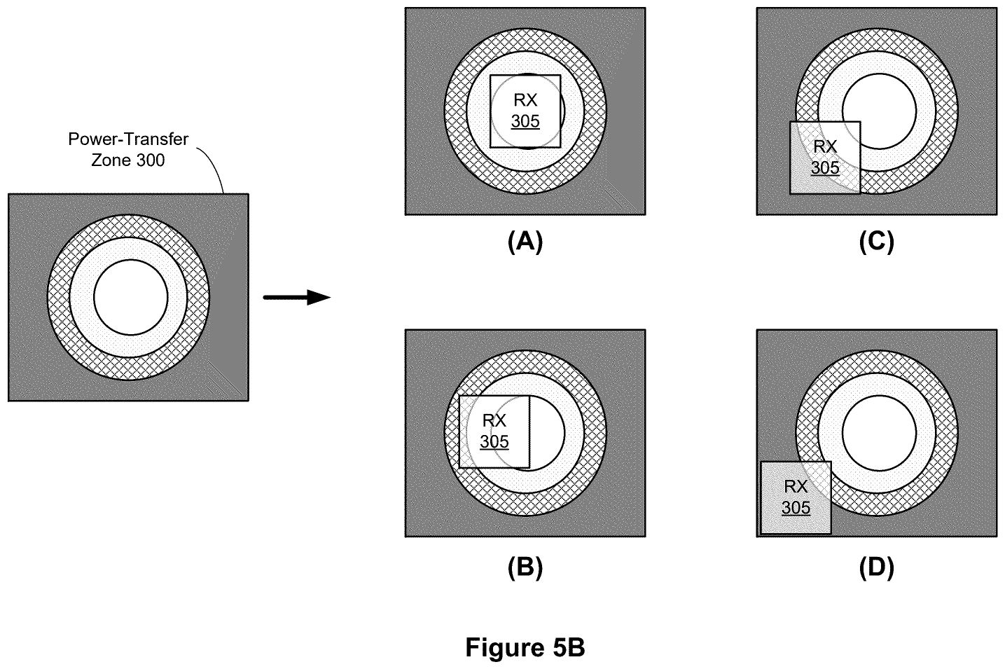

In some embodiments, the RF charging pad 100 further includes a signature-signal receiving circuit 240 (FIGS. 3A and 3E-3G), a reflected power coupler 242 (e.g., FIGS. 3A and 3E), and a capacitive charging coupler 244 (FIG. 5A).

The memory 206 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 206, or alternatively the non-volatile memory within memory 206, includes a non-transitory computer-readable storage medium. In some embodiments, the memory 206, or the non-transitory computer-readable storage medium of the memory 206, stores the following programs, modules, and data structures, or a subset or superset thereof:
Operating logic 216 including procedures for handling various basic system services and for performing hardware dependent tasks;
Communication module 218 for coupling to and/or communicating with remote devices (e.g., remote sensors, transmitters, receivers, servers, mapping memories, etc.) in conjunction with wireless communication component(s) 204;
Sensor module 220 for obtaining and processing sensor data (e.g., in conjunction with sensor(s) 212) to, for example, determine the presence, velocity, and/or positioning of object in the vicinity of the RF charging pad 100;
Power-wave generating module 222 for generating and transmitting power transmission signals (e.g., in conjunction with antenna zones 290 and the antennas 210 respectively included therein), including but not limited to, forming pocket(s) of energy at given locations. Power-wave generating module 222 may also be used to modify values of transmission characteristics (e.g., power level (i.e., amplitude), phase, frequency, etc.) used to transmit power transmission signals by individual antenna zones;
Database 224, including but not limited to:
   Sensor information 226 for storing and managing data received, detected, and/or transmitted by one or more sensors (e.g., sensors 212 and/or one or more remote sensors);
   Device settings 228 for storing operational settings for the RF charging pad 100 and/or one or more remote devices;
   Communication protocol information 230 for storing and managing protocol information for one or more protocols (e.g., custom or standard wireless protocols, such as ZigBee, Z-Wave, etc., and/or custom or standard wired protocols, such as Ethernet); and
   Mapping data 232 for storing and managing mapping data (e.g., mapping one or more transmission fields);
   Learned signature signals (not shown) for a variety of different wireless power receivers and other objects (which are not wireless power receivers, which are described in more detail below in reference to FIG. 9A;
a secure element module 234 for determining whether a wireless power receiver is authorized to receive wirelessly delivered power from the RF charging pad 100;
an antenna zone selecting and tuning module 237 for coordinating a process of transmitting test power transmission signals with various antenna zones to determine which antenna zone or zones should be used to wirelessly deliver power to various wireless power receivers (as is explained in more detail below in reference to FIGS. 9A-9B of incorporated-by-reference PCT Patent Application No. PCT/US17/65886);
an authorized receiver and object detection module 238 used for detecting various signature signals from wireless power receivers and from other objects, and then determining appropriate actions based on the detecting of the various signature signals (as is described in more detail below in reference to FIGS. 9A-9B); and
a signature-signal decoding module used to decode the detected signature signals and determine message or data content.

Each of the above-identified elements (e.g., modules stored in memory 206 of the RF charging pad 100) is optionally stored in one or more of the previously mentioned memory devices, and corresponds to a set of instructions for performing the function(s) described above. The above identified modules or programs (e.g., sets of instructions) need not be implemented as separate software programs, procedures, or modules, and thus various subsets of these modules are optionally combined or otherwise rearranged in various embodiments. In some embodiments, the memory 206, optionally, stores a subset of the modules and data structures identified above.

FIG. 2B is a block diagram illustrating a representative receiver device 104 (also sometimes called a receiver, power receiver, or wireless power receiver) in accordance with some embodiments. In some embodiments, the receiver device 104 includes one or more processing units (e.g., CPUs, ASICS, FPGAs, microprocessors, and the like) 252, one or more communication components 254, memory 256, antenna(s) 260, power harvesting circuitry 259, and one or more communication buses 258 for interconnecting these components (sometimes called a chipset). In some embodiments, the receiver device 104 includes one or more sensor(s) 262 such as the one or sensors 212 described above with reference to FIG. 2A. In some embodiments, the receiver device 104 includes an energy storage device 261 for storing energy harvested via the power harvesting circuitry 259. In various embodiments, the energy storage device 261 includes one or more batteries, one or more capacitors, one or more inductors, and the like.

In some embodiments, the power harvesting circuitry 259 includes one or more rectifying circuits and/or one or more power converters. In some embodiments, the power harvesting circuitry 259 includes one or more components (e.g., a power converter) configured to convert energy from power waves and/or energy pockets to electrical energy (e.g., electricity). In some embodiments, the power harvesting circuitry 259 is further configured to supply power to a coupled electronic device, such as a laptop or phone. In some embodiments, supplying power to a coupled electronic device include translating electrical energy from an AC form to a DC form (e.g., usable by the electronic device).

In some embodiments, the signature-signal generating circuit 315 includes one or more components as discussed with reference to FIGS. 3A-3D.

In some embodiments, the antenna(s) 260 include one or more of the meandering line antennas that are described in further detail below. In some embodiments, the antenna(s) 260 may also or alternatively include capacitive charging couplers that correspond in structure to those that may be present in a near-field charging pad.

In some embodiments, the receiver device 104 includes one or more output devices such as one or more indicator lights, a sound card, a speaker, a small display for displaying textual information and error codes, etc. In some embodiments, the receiver device 104 includes a location detection device, such as a GPS (global positioning satellite) or other geo-location receiver, for determining the location of the receiver device 103.

In various embodiments, the one or more sensor(s) 262 include one or more thermal radiation sensors, ambient temperature sensors, humidity sensors, IR sensors, occupancy sensors (e.g., RFID sensors), ambient light sensors, motion detectors, accelerometers, and/or gyroscopes.

The communication component(s) 254 enable communication between the receiver 104 and one or more communication networks. In some embodiments, the communication component(s) 254 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document.

The communication component(s) 254 include, for example, hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

The memory 256 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 256, or alternatively the non-volatile memory within memory 256, includes a non-transitory computer-readable storage medium. In some embodiments, the memory 256, or the non-transitory computer-readable storage medium of the memory 256, stores the following programs, modules, and data structures, or a subset or superset thereof:
Operating logic 266 including procedures for handling various basic system services and for performing hardware dependent tasks;
Communication module 268 for coupling to and/or communicating with remote devices (e.g., remote sensors, transmitters, receivers, servers, mapping memories, etc.) in conjunction with communication component(s) 254;
Sensor module 270 for obtaining and processing sensor data (e.g., in conjunction with sensor(s) 262) to, for example, determine the presence, velocity, and/or positioning of the receiver 103, a RF charging pad 100, or an object in the vicinity of the receiver 103;
Wireless power-receiving module 272 for receiving (e.g., in conjunction with antenna(s) 260 and/or power harvesting circuitry 259) energy from, capacitively-conveyed electrical signals, power waves, and/or energy pockets; optionally converting (e.g., in conjunction with power harvesting circuitry 259) the energy (e.g., to direct current); transferring the energy to a coupled electronic device; and optionally storing the energy (e.g., in conjunction with energy storage device 261);
Database 274, including but not limited to:
   Sensor information 276 for storing and managing data received, detected, and/or transmitted by one or more sensors (e.g., sensors 262 and/or one or more remote sensors);
   Device settings 278 for storing operational settings for the receiver 103, a coupled electronic device, and/or one or more remote devices; and
   Communication protocol information 280 for storing and managing protocol information for one or more protocols (e.g., custom or standard wireless protocols, such as ZigBee, Z-Wave, etc., and/or custom or standard wired protocols, such as Ethernet); and
a secure element module 282 for providing identification information to the RF charging pad 100 (e.g., the RF charging pad 100 uses the identification information to determine if the wireless power receiver 104 is authorized to receive wirelessly delivered power); and
a signature-signal generating module 283 used to control (in conjunction with the signature-signal generating circuit 315) various components to cause impedance changes at the antenna(s) 260 and/or power harvesting circuitry 259 to then cause changes in reflected power as received by a signature-signal receiving circuit 240.

Each of the above-identified elements (e.g., modules stored in memory 256 of the receiver 104) is optionally stored in one or more of the previously mentioned memory devices, and corresponds to a set of instructions for performing the function(s) described above. The above identified modules or programs (e.g., sets of instructions) need not be implemented as separate software programs, procedures, or modules, and thus various subsets of these modules are optionally combined or otherwise rearranged in various embodiments. In some embodiments, the memory 256, optionally, stores a subset of the modules and data structures identified above. Furthermore, the memory 256, optionally, stores additional modules and data structures not described above, such as an identifying module for identifying a device type of a connected device (e.g., a device type for an electronic device that is coupled with the receiver 104).

In some embodiments, the near-field charging pads disclosed herein may use adaptive loading techniques to optimize power transfer. Such techniques are described in detail in commonly-owned PCT Application No. PCT/US17/65886 and, in particular, in reference to FIGS. 3A-8 and 12-15, and the disclosures in this commonly-owned application is hereby expressly incorporated by reference in its entirety.

FIG. 3A is a block diagram of simplified circuits of an example wireless power-transfer zone 300 (e.g., one of the plurality of power-transfer zones 290A-N, FIG. 1B) located at the RF charging pad 100, and an example wireless power receiver 305 (e.g., an instance of the receiver 104, FIG. 2B), in accordance with some embodiments. In some embodiments, the wireless power receiver 305 includes a signature-signal generating circuit 315, as discussed with reference to FIGS. 3B-3D. It is noted that the power-transfer zone 300 may be referred to below, or illustrated in the Figures, as a transmitter (TX).

In some embodiments, an oscillator on the receiver device 305 includes one or more elements configured to control duty cycle and frequency and modulate a variable load 310 at the rectifier DC output port. In some embodiments, the rectifier voltage is encoded as frequency, and the rectifier load current is encoded as duty cycle (or vice versa). In some embodiments, the host 320 (e.g., CPU) controls the oscillator frequency and duty cycle, where each frequency/duty pair corresponds to a different message to be delivered to the power-transfer zone 300 located at the RF charging pad 100. In some embodiments, the receiver 305 includes a power-link monitoring chip with interfaces to the host 320 and the rectifier 306, and the power-link monitoring chip can also control the frequency/duty cycle of the oscillator. In some embodiments, the frequency and duty cycle variations are analyzed to recognize whether there are any foreign objects on the RF charging pad 100 (e.g., between the RF charging pad 100 and the receiver device 305 on top of the RF charging pad 100).

In some embodiments, the DC load modulation varies the impedance at the antenna interface 303 between the power-transfer zone 300 and the receiver 305. In some embodiments, the impedance change causes variations in reflected power (e.g., reflected power 340, FIG. 3B-1) at the receiver block 240 residing on the power-transfer zone 300, and such receiver block 240 decodes the variations to identify the reflected signals including information related to frequency and duty cycle (e.g., frequency and duty cycle are shown in FIG. 3E). In some embodiments, the rectifier loading conditions are known at the power-transfer zone 300. In some embodiments, it is determined whether the receiver host message is known at the transmit side to identify authorized receivers. In some embodiments, oscillator/modulator are enabled/disabled based on (1) configurable (voltage) threshold on rectifier DC output and/or (2) firmware control.

FIGS. 3B-1 and 3B-2 show block diagrams illustrating circuits including a rectifier 306 coupled to a variable load 310 of a receiver device (e.g., receiver device 305, FIG. 3A), in accordance with some embodiments. In some embodiments, the rectifier 306 converts RF power received at the RFin port into DC power at the Vrect port. In some embodiments, the amount of power received is dependent on the amount of power input by the antenna 313 (e.g., antenna(s) 260, FIG. 2B) of the receiver 305 and the impedance match between the antenna 313 of the receiver 305 and the rectifier 306. In some embodiments when the impedances of the antenna 313 and the rectifier 306 are matched, substantially all of the power from the antenna 313 enters the rectifier 306 and substantially none of the power is reflected (illustrated by lines 341 in FIGS. 3B-1 and 3B-2). When the impedances of the antenna 313 and the rectifier 306 are not matched, then some power from the antenna 313 is reflected off the rectifier 306 and the reflected power signals 310 are transmitted back to the antenna 313 (illustrated by lines 340 in FIGS. 3B-1 and 3B-2).

In some embodiments, the reflected power 340 is a source of system inefficiency in that it reduces the total amount of DC power that could be obtained from an available amount of RF power. In some embodiments, reflecting all, or a substantial portion, of the RF input power can be useful if no power is intended to be received at the receiver device 305. For example, if the host 320 battery is full, then the received power must be dissipated as heat somewhere in the receiver 305. Therefore, in some embodiments, it can be more thermally effective to reflect that power back out of the antenna 313.

In some embodiments, the reflected power signals 340 can be modulated for the purposes of data communications, as referred to as “load modulation” and this can be accomplished in some embodiments by placing a variable load 310 at the rectifier RFin port (FIG. 3B-1). In some embodiments in a load-modulated system, the amount of power reflected is controlled by a variable load 310 located at the RF input (FIG. 3B-1). This type of control has disadvantages: even when OFF, the variable load 310 introduces a loss at the RF frequency and therefore reduces the RF to DC conversion efficiency. In some embodiments, very high Q bandpass filters are needed to filter the modulation spectrum for regulatory compliance.

Controlling the amount of reflected power 340 may also be used for conveying data to a signature-signal receiving circuit 240 (e.g., included in a respective power-transfer zone of an RF charging pad). In some embodiments, the signature-signal receiving circuit 240 is a universal circuit for the NF charging pad 100 (i.e., the NF charging pad 100 includes a single signature-signal receiving circuit 240 that services each of the power-transfer zones 290). Alternatively, in some embodiments, each of the power-transfer zones (e.g., zone 300) includes its own signature-signal receiving circuit 240 (as shown in FIG. 3A).

In accordance with the embodiments disclosed herein, the inventors have determined that it is advantageous to locate the variable load 310 at the Vrect port (DC side) of the rectifier 306 (FIG. 3B-2), as is discussed in more detail below. In some embodiments, the variable load 310 can be moved to the DC side of the rectifier 306 (FIG. 3B-2). The rectifier 306 thus operates both as a downconverter (converting RF power to DC power) and an upconverter (converting the load modulation at Vrect to the RF frequency at RFin). In some embodiments, having the variable load 310 located at the DC side of the rectifier 306 solves disadvantages mentioned above that are present when the variable load 310 is placed at the RFin port.

FIG. 3C is a block diagram illustrating circuits including a reflect switch 311 within a wireless power receiver 305 (pictured in FIG. 3A) in accordance with some embodiments. In some embodiments, while the variable load 310 is used to reflect small amounts of power back out of the receive antenna 313, a reflect switch 311 is used to reflect all, or a substantial portion, of the received power. The reflect switch 311 could be located at the RFin port, however this would present the same disadvantages as discussed with reference to FIG. 3B-1, which illustrates an example of the variable load 310 coupled to the Rfin port. In some embodiments, these disadvantages are largely mitigated by placing the reflect switch 311 at the DC port (e.g., the Vrect port) of the rectifier 306. In some embodiments, when the reflect switch 311 is OFF, the reflect switch 311 does nothing. When the reflect switch 311 is ON, it presents a very low impedance (e.g., a short circuit) load at the DC side of the rectifier 306. Similarly, a low impedance load is seen at the RFin port of the rectifier 306, which presents a substantial impedance mismatch between the antenna 313 and the rectifier 306. Therefore, when the reflect switch 311 is ON, a substantial percentage of the input power from the antenna 313 is reflected back out of the antenna 313 and does not get converted to DC power by the rectifier 306.

FIG. 3D is a block diagram illustrating an example of a signature-signal generating circuit 315 of the wireless power receiver 305 in accordance with some embodiments. In some embodiments, the signature-signal generating circuit 315 includes a PFM/PWM (pulse-frequency modulation/pulse-width modulation) generator 309 to control the variable load 310 for generating a valid receiver “signature” (also referred to herein as a signature signal). In some embodiments, the signature-signal generating circuit 315 further includes (or is in communication with) a window comparator 307 to disable the control scheme unless sufficient power is available at Vrect to turn on all the circuitry. In some embodiments, the signature-signal generating circuit 315 further includes a current sensor 308 that converts the rectifier load current into a voltage which is received by the PFM/PWM generator 309. In some embodiments, the PFM/PWM generator 309 also senses Vrect directly. In some embodiments, the reflect switch 311 is also part of the signature-signal generating circuit 315.

In some embodiments, the window comparator 307, current sensor 308, and PFM/PWM generator 309, and any other auxiliary circuitry can be powered by power signals that are transmitted from the power-transfer zone 300, rectified by the rectifier 306, and supplied from the Vrect port, such that the system is independent of the host battery. Thus, even when the host battery of the receiver device 305 is completely dead, the signature-signal generating circuit 315 in the receiver device 305 can still be powered by the power signals received from the power-transfer zone 300 to generate signals with signatures. Such signals with signatures are further reflected back to the power-transfer zone 300 for sampling and analyzing whether there is any foreign object placed between the power-transfer zone 300 and the receiver 305, and/or whether the receiver 305 is authorized to receive power from the power-transfer zone 300 (or the charging pad 100 in general).

In some embodiments, the PWM/PFM generator 309 converts the current sense and voltage sense inputs to a pulse train where the pulse frequency is dependent on the sensed current and the pulse width is dependent on the sensed voltage (or vice versa). In some embodiments, the pulse train is applied to the variable load 310, which therefore represents a pulsed load at the port Vrect, and this pulsed load is upconverted to RF by the rectifier 306 as previously explained. Ultimately, the pulsed load will be sensed by the power-transfer zone 300 for sampling and analyzing.

FIG. 3E illustrates a block diagram that shows an example power-transfer zone 300 including a signature-signal receiving circuit 240 in accordance with some embodiments. In some embodiments, the coupling network impedance is sensed by the reflected power coupler 242. In some embodiments, the reflected power coupler 242 is used to measure the impedance being reflected back from the receiver 305 to the antenna 302 (e.g., antenna 210, FIG. 1B) of the power-transfer zone 300. In some embodiments, due to a mismatch between the power-transfer zone 300 and the receiver 305 caused by an interference from a foreign object or a signal exchange with an authorized receiver, some power signals are being reflected by the receiver 305. A portion of such reflected power signals 340 is received at the power-transfer zone 300′s antenna 302, and the impedance is measured by the reflected power coupler 242 at the power-transfer zone 300. After comparing the received reflected power 340 and the original transmitted power, the power-transfer zone 300 can determine an extent of a mismatch between the power-transfer zone 300 and the receiver 305. For example, if 1/10 of the reflected power 340 received at the power-transfer zone 300 can be sensed by the reflected power coupler 242, and when 1/10 of the original transmitted power is received at the reflected power coupler 242, it can be determined that the receiver 305 does not take any power signals from the power-transfer zone 300.

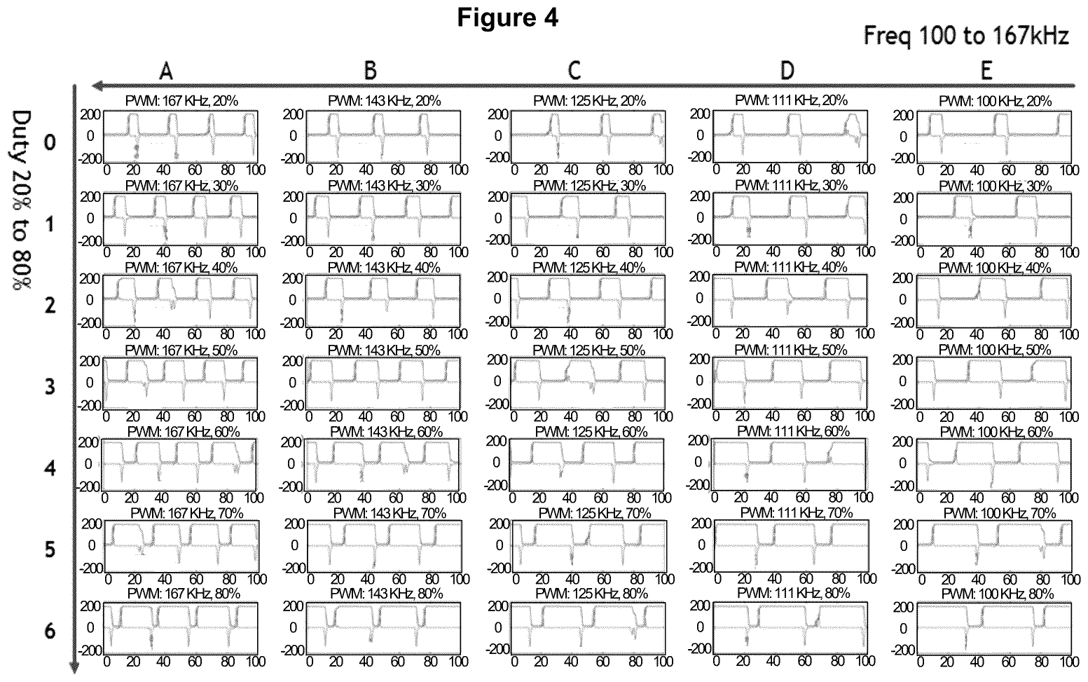

In some embodiments, the reflected power signals 340 received from the receiver 305 are processed and analyzed by the signature-signal receiving circuit 240. For example, the received reflected signal 340 is amplified, filtered, and demodulated using an amplitude modulator (AM) detector 350. In some embodiments, an automatic gain control (AGC) is implemented. In some embodiments, after demodulation, the digitally-sampled signals are matched with antenna fingerprint, e.g., by data analysis block 356. In some embodiments, the rectifier loading conditions are sensed. In some embodiments, Message ID is decoded from the received reflected signals as further shown in FIG. 4 (and discussed further below).

FIGS. 3F-3H show respective block diagrams illustrating various example circuits of power-transfer zones 300 and wireless receivers 305 in accordance with some embodiments. In some embodiments, the pulsed load at RFin modulates the amount of reflected power 340 which propagates out of an antenna 313 of the wireless power receiver 305. In some embodiments, some of this reflected power enters the transmitting antenna 302 (also referred to as a “power-transferring element”), and some of that in turn is coupled into the receive port of the load-modulation receiver on the power-transmitter unit. As discussed below, the reflected power is received using an AM receiver topology with variable gain stages and AGC for optimal SNR adjustment. In some embodiments, if a foreign object 360 is placed on the receiver 305, there is also reflected power from the surface of the foreign object 360, which is also sensed by the AM receiver 350.

In some embodiments, the received data stream is analyzed to extract the receiver signature waveform (its “signature signal”). In some embodiments, if the object is a valid receiver 305, then the signature signal is the PWM/PFM pulse train previously described. Upon correctly decoding the pulse train (or lack thereof), the power-transfer zone 300 can determine the system state from among the following options: 1) no object on top, 2) one or more foreign objects on top, 3) valid receiver only, and 4) foreign object in between receiver and a surface of the RF charging pad.

In some embodiments, upon detection of a wireless power receiver 305, the power-transfer zone 300 may apply several power levels and measure changes in the PWM/PFM pulse train to authenticate an authorized receiver.

In some embodiments, other messages may be passed from the receiver 305 to the power-transfer zone 300 using the “control” pin(s) which can modify load modulation. In some embodiments, the messages received by the power-transfer zone 300 can be sampled and analyzed to obtain informing regarding receiver conditions, such as battery status (e.g., full/dead/other), temperature, rectifier voltage/current, and future intended actions such as intention to turn on the reflect switch 311.

In some embodiments, the transmission of power signals coexists with other wireless protocols. For example, if the host 320 intends to send or receive wireless (Bluetooth, WiFi, LTE, etc.) traffic but cannot because the power-transfer zone 300 is on and is interfering with the Bluetooth system, the host 320 may wish to stop the power-transmission for an interval to clear the wireless traffic, and then continue the power-transmission. Techniques for managing coexistence of power and data signals are described in commonly-owned U.S. Provisional Patent Application 62/579,049, filed on Oct. 30, 2017, which is hereby incorporated by reference in its entirety.

In some embodiments, the host 320 (shown in FIG. 3H) can obtain control of the load modulation using the “control” input. In some embodiments, the host 320 can force certain PWM/PFM combinations which are then interpreted as pre-defined messages by the power-transfer zone 300. Examples of such pre-defined messages are discussed with reference to FIG. 4 below.

In some embodiments, the host 320 controls the reflect switch 311. When the reflect switch 311 is turned on, Vrect is drawn below the window comparator threshold and the PWM/PFM 309 stops. In this case, the power-transfer zone 300 detects the absence of a valid receiver signature. The actions under this scenario are programmable per application. In some embodiments, a switch 312 (i.e., receiver-side switch) to the host power input is controlled via the host 320 and also via the window comparator 307 such that the host 320 cannot overload the rectifier 306 during system startup.

FIG. 4 lists example messages encoded using signature signals in PFM/PWM pairs, in accordance with some embodiments. In some embodiments, the Frequency/duty pairs (also PFM/PWM pairs) can be selected on the receiver side and interpreted on the transmitter side as passing specific messages. FIG. 4 lists an example plot of 42 frequency/duty pairs, and each pair has a different meaning used to control the power transfer link, implementing coexistence and foreign object detection (FOD). In some embodiments, the PFM/PAM pairs shown in A0-A6 are decoded as a request from the receiver 305 to the power-transfer zone 300 to reduce power by various amounts. In some embodiments, the PFM/PAM pairs shown in B0-B6 are decoded as a request from the receiver 305 to the power-transfer zone 300 to increase power by various amounts. In some embodiments, the PFM/PAM pairs shown in C0-C6 are decoded as a request from the receiver 305 to the power-transfer zone 300 to stop transmitting for various lengths of time then restart, or stop forever.

FIG. 5A illustrates a simplified diagram showing a highly-coupled near-field capacitive coupler 244 (e.g., FIG. 2A) that is used in a power-transfer zone 300 in accordance with some embodiments (e.g., the coupler 244 can be the antenna 302 discussed above with reference to FIGS. 3A-3H). In some embodiments, the highly-coupled near-filed capacitive coupler 244 is coupled to the power amplifier 108 and the signature-signal receiving circuit 240 (FIG. 3A). In some embodiments, the highly-coupled near-field capacitive coupler 244 operates in one of the ISM frequency bands. In some embodiments, no electromagnetic (EM) propagation occurs in the current system. Rather, the wireless power is transmitted and received via capacitive coupling elements between the power-transfer zone 300 and the receiver 305. In some embodiments, the capacitive coupling occurs when two coupling elements (one on transmitter side and one on receiver side) are placed in front of each other in an optimum position when desired stackup is placed between two coupling elements.

In some embodiments, there is no limit on the shape, size, and number of the center coupler 502 and parasitic elements 504. In some embodiments, the parasitic elements 504 can be in the same level as the center coupling element 502 or at a higher or a lower level from the center coupling element 502. In some embodiments, the parasitic elements 504 are placed around the center coupling element 502 to extend X-Y coverage within the planar area of the capacitive coupler 244. In some embodiments, the system is formed as a two-conductor capacitor. In some embodiments, when the coupling elements of the receiver 305 and the power-transfer zone 300 are misaligned, the parasitic elements 504 are effective in forming a multi-conductor capacitive system to maximize the power transfer from the power-transfer zone 300 to the receiver 305. In some embodiments, to measure the reflected RF power to the power amplifier 108, there is a coupler circuitry 242 (in a form of a chip or printed lines, as shown in FIG. 3A) to sample the reflected RF power signals 340. In some embodiments, the capacitive charging coupler 244 includes a reflecting plane.

In some embodiments, when the receiver antenna 313 is placed on top of the transmitting antenna 302 (e.g., one of the capacity charging couplers 244), the system shows coupling efficiency of more than a predetermined threshold value (e.g., a minimum acceptable value, such as 70%). In some embodiments, when the transmitting antenna 302 and receiver antenna 313 are completely standalone, the system is mismatched. As soon as these antennas are placed on top of each-other, both antennas get matched. In some embodiments, the coupling system only works when the designed receiver is placed on top of the transmitting antenna 302. In case of a foreign object 360 being placed on top of the power-transfer zone 300, the transmitting antenna 313 is not matched. Such mismatch induced by a foreign object 360 can be used to detect a foreign object 360 placed between the power-transfer zone 300 and the receiver 305.

In some embodiments, the coupling between the receiver 305 and the power-transfer zone 300 reaches a peak when the receiver antenna 313 and the transmitting antenna 302 are fully aligned/centered (e.g. 90%). In some embodiments, as the receiver antenna 313 moves over the transmitting antenna 302, the coupling performance drops, but it remains within an acceptable range (e.g. stays within 70-90%). In some embodiments, when receiver antenna 313 moves outside the minimum coupling range (e.g. 70%), the second/adjacent transmitting antenna 302 gets activated for a smooth transition.

In some embodiments, both transmitter and receiver antennas are mismatched, and when the correct placement occurs, both transmitting antenna 302 and receiver antenna 313 get matched and the maximum power can be obtained from transmitting antenna 302 to receiver antenna 313. In some embodiments, highly-coupled near field antenna pairs only work in presence of each other. Therefore, in presence of other types of receiver antennas and/or any other foreign objects, the transmitting antenna 302 stays mismatched.

FIG. 5B shows a plurality of efficiency maps corresponding to various embodiments when the receiver 305 is placed over different regions of a power-transfer zone 300 that includes one or the couplers 244 in accordance with some embodiments. In some embodiments, highly-coupled antenna pairs can be treated as state-machines. In some embodiments as shown in FIG. 5B, the power-transfer zone 300 includes multiple areas with respective charging efficiencies when a receiver 305 is displaced on top of the corresponding areas. When the receiver 305 is placed on top of the white zone (efficiency >90%) of the power-transfer zone 300 (A—top-left map), the matching of both the receiver 305 and power-transfer zone 300 is better than −15 dB. When the receiver 305 is placed on top of the stippled zone (80%<efficiency<90%) of the power-transfer zone 300 (B—bottom-left map), the matching of both the receiver 305 and power-transfer zone 300 is in a range of −10 dB to −15 dB. When the receiver 305 is placed on top of the cross-hatched zone (70%<efficiency<80%) of the power-transfer zone 300 (C—top-right map), the matching of both the receiver 305 and power-transfer zone 300 is in a range of −5 dB and −10 dB. When the receiver 305 is placed on top of the darker zone (efficiency<70%) of the power-transfer zone 300 (D—bottom-right map), the matching of both the receiver 305 and power-transfer zone 300 is worse than −5 dB.

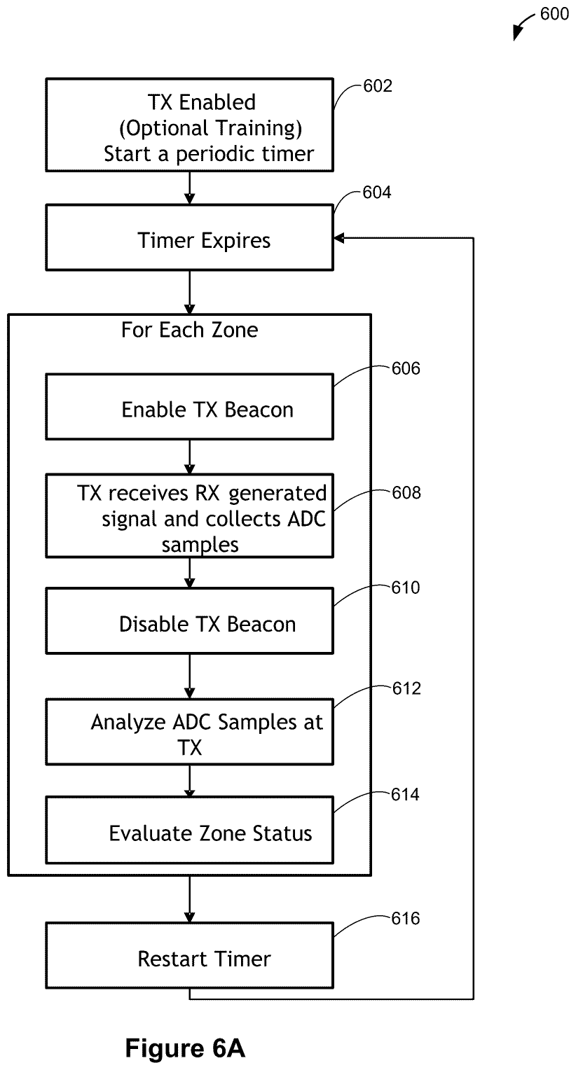

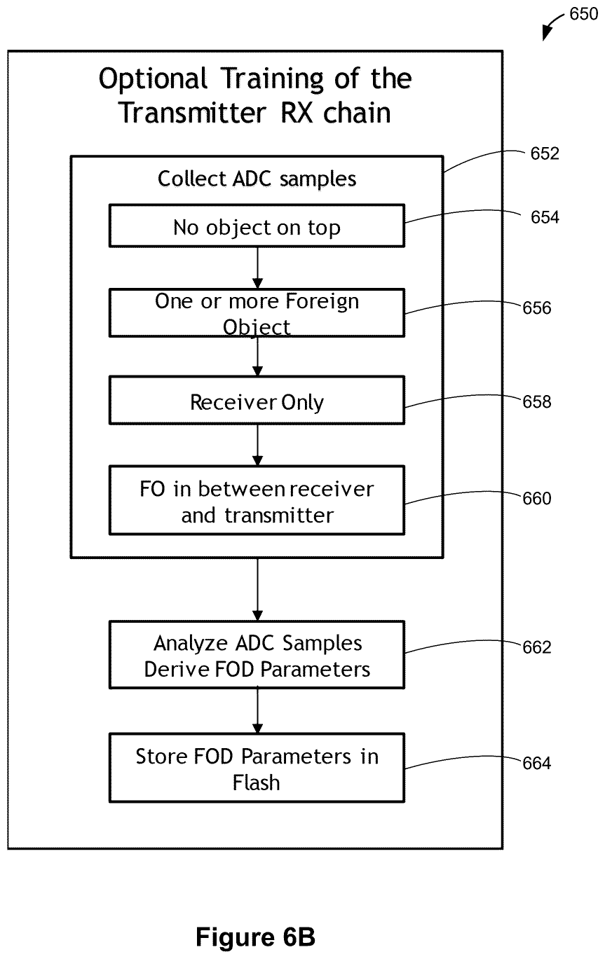

FIG. 6A is a flow diagram 600 showing a process of detecting a receiver 305 by sending beacon signals (also referred to herein as “test power transmission signals”) periodically in accordance with some embodiments. In some embodiments, each power-transfer zone starts (602) a timer so as to send beacon signals periodically. In some embodiments, when the timer expires (604), each power-transfer zone of the NF charging pad (also referred to herein as an RF charging pad) 100 sends a beacon signal (606). The signature-signal generating circuit 315 of the receiver 305 (e.g., as discussed in FIGS. 3A and 3E) can generate signature-signals based on the beacon signal. Thereafter, each power-transfer zone receives (608) the receiver 305 generated signature-signals and collects analog-to-digital converter 354 (ADC) samples. The transmitter beacon signal is disabled (610), the samples from ADC 354 are analyzed (612), and the zone status is evaluated (614) (e.g., as discussed with reference to FIG. 5B). After the zone status is determined and the matching between each respective zone and the receiver 305 is evaluated, the timer is restarted (616) to start the next period for sending beacon signals. In some embodiments, the start step (602) includes an optional training process as discussed with reference to FIG. 6B (and in more detail below in reference to FIG. 9A).

FIG. 6B is a flow diagram 650 showing a process of optional training performed by the power-transfer zone 300 in accordance with some embodiments. In some embodiments, optional training is an embodiment for aiding foreign object detection (FOD) using signature-signal-based detection. In some embodiments, this can be done at one time with known sets of receivers and FOD devices. In some embodiments, enough ADC samples are collected (652) to enable classification of FOD, and the derived parameters provide the ability to classify the object detection status including (1) no object present (654), (2) one or more foreign objects present (654), (3) receiver only present (658), and (4) foreign object in between receiver 305 and power-transfer zone 300 (660). The process further includes analyzing (662) ADC samples to derive FOD parameters, and storing (664) the FOD in memory (e.g., in non-volatile memory). More details regarding example training/learning processes are described below in reference to FIG. 9A.

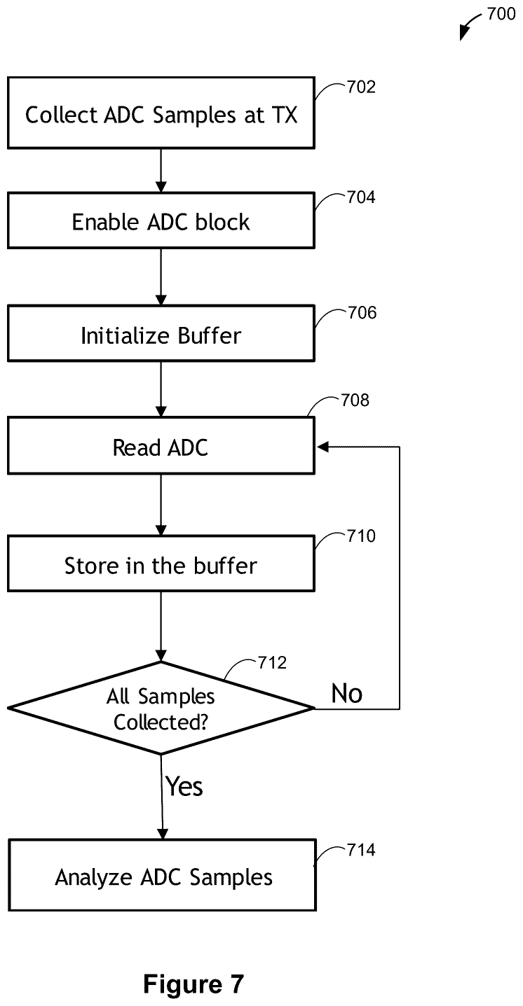

FIG. 7 is a flow diagram 700 showing a process of collecting, storing, and analyzing ADC samples performed by the power-transfer zone 300 in accordance with some embodiments. In some embodiments, collecting the ADC samples begins at a step 702, and sampling may continue as a preconfigured tight loop in firmware. In some embodiments, firmware runs an optimized loop to collect and store the ADC data in a buffer, which includes enabling (704) the ADC block, initializing (706) the buffer, reading (708) the ADC for data, storing (710) the collected data (e.g., ADC samples) in the buffer. Next, it is determined whether all the ADC samples are collected (712). If all the ADC samples are collected (712-Yes), then the samples are analyzed (714). However, if all the samples are not collected (712-No), then the process 700 loops back to the reading the ADC (step 708). This can be subjected to timing variation and result in inaccuracies. These variations can be minimized by collecting samples multiple times and averaging to remove the noise.

In some embodiments, operation 702 is hardware (HW) assisted. For example, at operation 702 harward is used to sample the ADC values at fixed intervals in a pre-defined buffer. Once all the samples are collected, firmware will be notified and subsequent operations shown in FIG. 7 may continue. This guarantees tight timing for sampling and gives more accurate result. Also the firmware is not blocked in a dead loop of collecting samples.

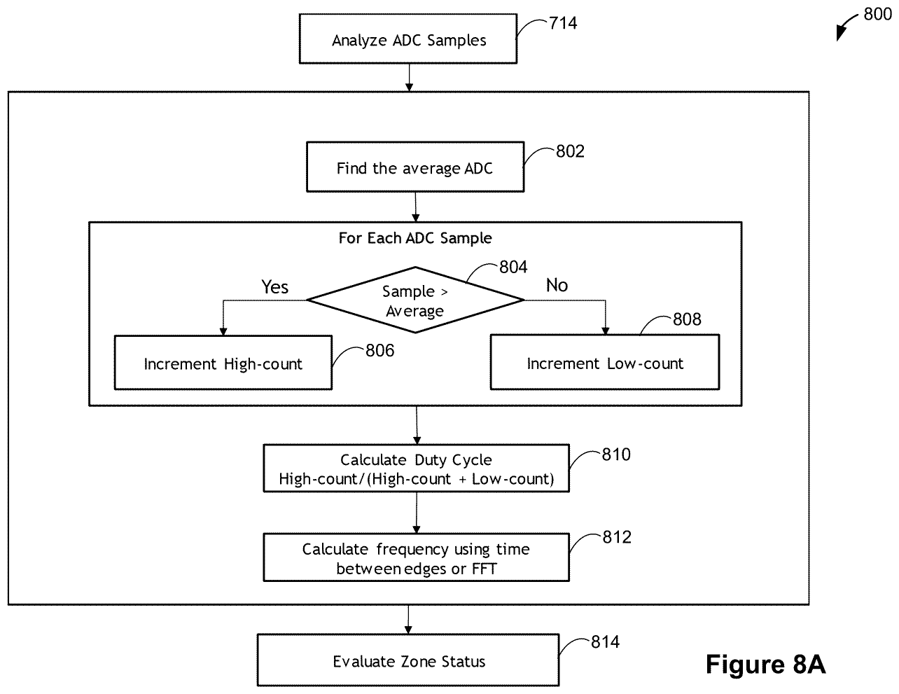

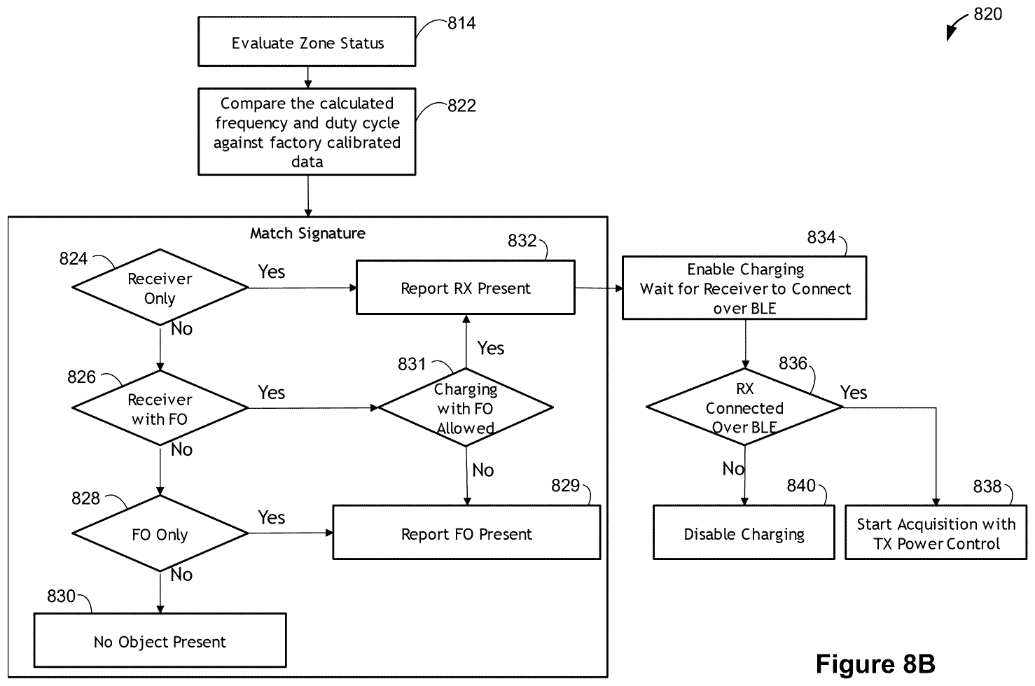

FIG. 8A is a flow diagram 800 showing a process of analyzing ADC samples performed by a power-transfer zone 300 in accordance with some embodiments. In some embodiments, after the ADC samples are collected (714), a baseline of the collected ADC samples is determined. In one example, the average of the collected ADC samples is determined (802). Then each ADC sample is compared against the determined baseline, e.g., the average of the collected ADC samples (804). When an ADC sample is greater than the calculated average (804-Yes), a high-count is incremented (806). When an ADC sample is lower than the calculated average (804-No), a low-count is incremented (808). Then a duty cycle is calculated (810) by: high-count/(high-count+low-count), and a frequency is calculated (812) using time between edges of Fast Fourier transform (FFT). The calculated duty cycle and the frequency are used for evaluating zone status (814) as discussed with reference to FIG. 8B.

FIG. 8B is a flow diagram 820 showing a process of evaluating zone status (814) to determine whether there is a foreign object and/or a receiver present in accordance with some embodiments. In some embodiments, the calculated frequency and duty cycle are compared (822) against factory-calibrated data. It is then determined whether only a receiver is present (824). In accordance with a determination that only a receiver is present (824-Yes), the presence of the receiver is reported (832) and the charging of the receiver by the antenna zone (e.g., by the power-transfer zone 300) is enabled (834). In some embodiments, the system waits (836) for the receiver to connect over Bluetooth. When the receiver is connected over Bluetooth (836-Yes), the wireless power signals are acquired from the transmitter power control (838). When the receiver is not connected over Bluetooth (836-No), the charging of the receiver is disabled (840).

In some embodiments, when it is determined that a receiver is present, it is also determined whether a foreign object is present with the receiver. In some embodiments, when a receiver 305 and a foreign object 360 are identified (826), the charging of the receiver with the foreign object is allowed (831); and, then the charging process can be enabled. In some embodiments, when only foreign object is detected (828), the presence of the foreign object is reported (829). In some embodiments, when no foreign object is detected, it is determined that no object (830), e.g., neither a receiver nor a foreign object, is present.

FIGS. 9A-9B are flow diagrams showing a method 900 of operating a near-field charging pad, in accordance with some embodiments. Operations of the method 900 are performed by a near-field charging pad (e.g. RF charging pad 100, FIGS. 1B and 2A) or by one or more components thereof (e.g., those described above with reference to FIGS. 1A-1B and 2A). In some embodiments, the method 900 corresponds to instructions stored in a computer memory or computer-readable storage medium (e.g., memory 206 of the RF charging pad 100, FIG. 2A).

The near-field charging pad includes one or more processors (e.g., CPU 202, FIG. 1B), a wireless communication component (e.g., communication component(s) 204, FIGS. 1A and 2A), and a plurality of power-transfer zones (e.g., antenna zones 290-1 and 290-N, FIG. 1B; power-transfer zone 300, FIG. 3A) that each respectively include at least one power-transferring element (e.g., one of antennas 210, FIG. 2A, which may be one of the antennas 120 described in reference to FIGS. 3A-6E in commonly-owned PCT Application No. PCT/US17/65886, which was incorporated by reference above, the antennas 210 may also be one or more of the capacitive couplers 244 described above in reference to FIG. 5A) and a signature-signal receiving circuit (e.g., the circuit 240 described above in reference to FIGS. 2A, 3A and 3E-3H, and the signature-signal receiving circuit may also include a reflected power coupler 242) (902).

In some embodiments, the near-field charging pad includes distinct power-transferring elements that are each included in respective power-transfer zones. For example, as shown in FIG. 1B, an antenna zone 290-1 includes an antenna 210-A. In another example, as is also shown in FIG. 1B, an antenna zone 290-N includes multiple antennas. The antenna zones may also be referred to as antenna groups, such that the near-field charging pad includes a plurality of antenna/power-transfer zones or groups, and each respective zone/group includes at least one of the distinct antenna elements (e.g., at least one antenna 210). It should be noted that an antenna/power-transfer zone can include any number of antennas, and that the numbers of antennas associated with a particular antenna/power-transfer zone may be modified or adjusted (e.g., the CPU subsystem 170 of RF power transmitter integrated circuit 160 responsible for managing operations of the near-field charging pad 100 dynamically defines each antenna/power-transfer zone at various points in time). In some embodiments, each antenna/power-transfer zone includes a same number of antennas/power-transferring elements.

In some embodiments, the one or more processors are a component of a single integrated circuit (e.g., RF power transmitter integrated circuit 160, FIG. 1B) that is used to control operation of the near-field charging pad. In some embodiments, the one or more processors and/or the wireless communication component of the near-field charging pad is/are external to the near-field charging pad, such as one or more processors of a device in which the near-field charging pad is embedded. In some embodiments, the wireless communication component is a radio transceiver (e.g., a BLUETOOTH radio, WI-FI radio, or the like for exchanging communication signals with wireless power receivers).

In some embodiments and with reference to FIG. 9A, the method 900 includes optionally learning (904) signature signals for different wireless power receivers (e.g., receiver 305, FIG. 3A) and for other objects (e.g., foreign object 360, FIG. 3G), and these learned signature signals are stored in a data source (which may be a local memory of the near-field charging pad or which may be hosted externally to the near-field charging pad).

In some embodiments, the one or more processors of the near-field charging pad are in communication with the data source into which each of the learned signature signals is stored. The data source may be hosted internally or externally to the near-field charging pad. In some embodiments, the data source is populated with the one or more predefined signature signals during a configuration process in which each of a plurality of different wireless power receivers is placed on the near-field charging pad to allow the near-field charging pad to detect and then store (in the data source) a respective predefined signature signal for each of the plurality of different wireless power receivers. In some embodiments, after a respective signature signal is learned for a respective wireless power receiver of the different wireless power receivers, a user may provide an indication as to whether the respective wireless power receiver is an authorized wireless power receiver or not. In this way, the near-field charging pad is able to learn signature signals for both authorized and unauthorized wireless power receivers.

In some embodiments, the configuration process also includes placing a plurality of different objects (e.g., keys, coins, various types of liquids, credits cards, coffee mugs, or any other type of household object that a user might place on the near-field charging pad), which are not wireless power receivers, on the near-field charging pad to allow the near-field charging pad to detect and then store (in the data source) a respective predefined signature signal for each of the plurality of different objects.

In some embodiments, during this configuration process, identifiers for each of the different objects are also stored with each of the respective stored signature signals, thereby allowing the near-field charging pad to identify different types of objects based on matching a signature signal to one of the stored signals.

In some embodiments, during the configuration process, signature signals are also learned for combinations of the different wireless power receivers and the plurality of different objects (e.g., each of the different objects may be placed underneath or on top of each of the different wireless power receivers), and these signature signals are also stored in the data source.

Certain implementations of the near-field charging pad may be implemented so that detection of one of the different objects causing the near-field charging pad to cease any transmission of power. In this way, potential damage to any of the different objects may be avoided.

The method 900 also includes sending (906), by a respective power-transferring element included in a first power-transfer zone of the plurality of power-transfer zones, a plurality of test power transmission signals (also termed beacon power transmission signals) with first values for a first set of transmission characteristics. In some embodiments, the first values for the first set of transmission characteristics include a power level for each of the plurality of test power transmission signals that is less than a certain power threshold (e.g., 30 dB).

In some embodiments, the sending operation 906 is performed based on a predefined time interval, such that at every predefined time interval the test power transmission signals are sent by the first power-transfer zone. In some embodiments, the predefined time interval is 1 second, 2 seconds, or 5 seconds, or some value therebetween. In some embodiments, the near-field charging pad includes a data-communication radio (e.g., a wireless communication component 254, such as a BLUETOOTH radio), and the sending of the plurality of test power transmission signals is performed without receiving any signal via the data-communication radio.

In other words, by allowing the method 900 to begin without requiring receipt of any signal via the data-communication radio, the method 900 is used to detect that an authorized receiver is present on the near-field charging pad even when that receiver has no charge in its power sources (e.g., its battery is completely drained). Additionally, the method 900 is also used to detect authorized receivers on the pad which do not have any data-communication radios at all.

In conjunction with sending each of the plurality of test power transmission signals, the method also includes detecting (908), using the signature-signal receiving circuit, respective amounts of reflected power (e.g., reflected signals 340, FIG. 3F) at the first power-transfer zone. The respective amounts of reflected power may include amounts of power from each of the test power transmission signals that are reflected back to the first power-transfer zone. As is discussed in more detail below, these respective amounts of reflected power may be used to allow the near-field charging pad to determine whether an authorized wireless power receiver is located on the near-field charging pad.

Based at least in part on the respective amounts of reflected power, the method 900 then includes determining whether (i) an authorized wireless power receiver and/or (ii) an object other than a wireless power receiver is present on a surface of the near-field charging pad that is adjacent to the first power-transfer zone (e.g., a surface of the pad that is immediately above the first antenna zone). In some embodiments, this determination is based at least in part on the respective amounts of reflected power, because the near-field charging pad generates (910) a signature signal based on the respective amounts of reflected power (e.g., an example way to generate the signature signals based on the reflected amount of power is shown in FIGS. 3F-3H, 6A-6B, 7, and 8A-8B) and then compares (912) the generated signature signal to the learned signature signals stored in the data source.

In some embodiments, the signature signal is conveyed to the signature-signal receiving circuit of the first power-transfer zone by encoding the one or more signature signals using manipulations to an impedance value(s) at the wireless power receiver, the manipulations to the impedance value(s) causing the amounts of reflected power to vary at different points in time.

In some embodiments, the manipulations to the impedance value cause the signature-signal receiving circuit to detect variations in the measurements of reflected power and these variations may be decoded to produce the one or more signature signals. In some embodiments, the one or more signature signals comprise a combination of frequency and duty cycle values. An example as to how this may work is described with reference to FIGS. 3F-3H, 4, and 8A-8B. In some embodiments, in addition to conveying information regarding whether a wireless power receiver is authorized to receive power from the pad, the one or more signature signals may also be used to convey additional data or messages to the pad. Examples as to how data may be encoded using the signature signals are shown in FIGS. 3F-3H, 4, and 8A-8B.

Turning now to FIG. 9B, the method 900 includes determining (914) whether the signature signal indicates that an authorized receiver and/or any other object (that is not a wireless power receiver) is present on a surface of the first power-transfer zone.

In accordance with a determination that the signature signal indicates that both a receiver and some other object (which is not a wireless power receiver) are present on the surface of the first power-transfer zone, the method 900 then includes determining (920) whether the near-field charging pad is configured to send wireless power while objects (which are not wireless power receivers) are present on the pad.

If it is determined that the pad is configured to send wireless power while objects (which are not wireless power receivers) are present on the pad (920-Yes), then the method 900 includes sending (916), via the power-transferring element, additional power transmission signals with second values for the first set of transmission characteristics to the authorized wireless power receiver.

If it is determined that the pad is not configured to send wireless power while objects (which are not wireless power receivers) are present on the pad (920-No), then the method 900 includes waiting for a timer to expire (922), e.g., waiting for a period of a second or two seconds to pass) and then returning to operation 906 of FIG. 9A.

An additional example of detecting a wireless power receiver and some other object on the surface of the first power-transfer zone is provided below. In this example, the determination (914-Receiver+Object) that both a wireless power receiver and some other object are present on the surface of the first power-transfer zone is based on the comparison (912) of the signature signal with the one or more predefined signature signals stored in the data source. In this example, the method 900 then determines that the near-field charging pad is configured to send power transmission signals while an object other than a wireless power receiver is present on the near-field charging pad; and, after determining that the near-field charging pad is configured to send power transmission signals while an object other than a wireless power receiver is present on the near-field charging pad, the power-transferring element of the first power-transfer zone is then used to send the additional power transmission signals.

In some embodiments, different, third values for the first set of transmission characteristics are used to send the additional power transmission signals when it is determined that an object other than a wireless power receiver is present on the pad. For example, a power level of the additional power transmission signals may be lowered (relative to a power level that is used for the second values for the first set of transmission characteristics) to avoid any potential damage to the object other than the wireless power receiver (e.g., to avoid damaging or destroying a magnetic strip present on a credit card).

Referring back to FIG. 9B, when it is determined at operation 914 that only an authorized receiver is present on the surface of the first power-transfer zone (914-Receiver Only), then the method proceeds to send, via the power-transferring element, additional power transmission signals with the second values for the first set of transmission characteristics to the authorized wireless power receiver. One specific example of detecting just a receiver is also provided below. In this example, and as was discussed in reference to operations 910 and 912, the detected amounts of reflected power at the first power-transfer zone may be used to then determine, using the signature-signal receiving circuit, the signature signal based at least in part on the respective amounts of reflected power at the first power-transfer zone. An example process for collecting measurements of reflected power and collecting the one or more signature signals is shown in FIGS. 8A-8B.

In this example, the method 900 also includes determining, based on a comparison of the signature signal with one or more predefined signature signals, that only an authorized wireless power receiver is present on the surface of the near-field charging pad that is adjacent to the first antenna zone. In some embodiments, the authorized wireless power receiver includes a signature-signal generating circuit (e.g., circuit 315, FIG. 3A) that uses power harvested from the plurality of test power transmission signals to generate the one or more signature signals (as is described in more detail in reference to FIGS. 3A-3D and 3F-3H). In this example, in accordance with the determining that only the authorized wireless power receiver is present on the surface, the method 900 further includes transmitting, by the respective power-transferring element included in the first antenna zone, additional power transmission signals with the second values for the first set of transmission characteristics.

In some embodiments, the signature-signal receiving circuit (e.g., circuit 240, FIG. 3A) at the first power-transfer zone is configured to detect measurements of reflected power at the first antenna zone and these measurements may change based on the presence or absence of objects on a surface adjacent to the first antenna zone (e.g., a surface of the pad that is immediately above the first antenna zone). Additionally, the signature-signal generating circuit may be configured to cause impedance changes at the wireless power receiving, which allows for the generation of different signature signals by the signature-signal generating circuit and, thereby, to cause the receipt of the different signature signals at the signature-signal receiving circuit of the first antenna zone. As discussed above (e.g., in reference to FIGS. 3F-3H, 5, and 8A-8B), this allows for creation of a scheme in which authorized wireless power receivers may be detected based on the different signature signals, and unauthorized wireless power receivers may be ignored, to avoid allowing unauthorized devices to leach power from the system.

Also referencing FIG. 9B, when it is determined that only an object (which is not a wireless power receiver) is present on the surface of the first power-transfer zone, then the method 900 includes waiting for a timer to expire (918) (e.g., waiting for a period of a second or two seconds to pass) and then returning to operation 906 of FIG. 9A.

Referring back to FIG. 9A, and to allow for detecting either multiple wireless power receivers on the pad and/or to detect objects and receivers located over different power-transfer zones of the pad, the method 900 may also include repeating (906A) operations 906-912 for each power-transfer zone of the plurality of power-transfer zones.

For example, in conjunction (either at the same time as or during different, non-overlapping time periods) with the sending (906) of the plurality of test power transmission signals, the method 900 may also include sending a respective plurality of test power transmission signals by respective power-transferring elements included in each power-transfer zone of the plurality of power-transfer zones; detecting, using respective signature-signal receiving circuits included in each respective power-transfer zone of the plurality of power-transfer zones, respective amounts of reflected power at each of the plurality of power-transfer zones; and determining, for each power-transfer zone of the plurality of power-transfer zones, whether (a) a wireless power receiver or (ii) an object other than a wireless power receiver is present at a respective surface adjacent to each of the plurality of power-transfer zones.

Continuing the example, based on the respective amounts of reflected power detected at a second power-transfer zone of the plurality of power-transfer zones, the method 900 may include: determining that an object other than a wireless power receiver is present at the second power-transfer zone; and in accordance with determining that the object other than a wireless power receiver is present at the second power-transfer zone, determining whether the near-field charging pad is configured to transmit wireless power while one or more objects are present on the near-field charging pad. In embodiments in which an object other than a wireless power receiver is detected at a power-transfer zone different from a zone over which an authorized wireless power receiver is detected, the sending of the additional power transmission signals is only performed after determining that the near-field charging pad is configured to send wireless power while one or more objects are present on the near-field charging pad.

In some embodiments, the near-field charging pad is configured with a parameter that indicates whether it is allowed to send power while foreign objects (e.g., objects other than wireless power receivers) are present on the pad. For instance, an owner or operator of the pad may set this parameter during a setup procedure for the pad. In some embodiments, the classifying may also be performed in a more granular fashion, e.g., to determine types of objects that are not wireless power receivers (e.g., metallic objects, non-metallic objects, credit cards, spilled liquids, etc.).

In some embodiments, the power transmission signals discussed above are radio frequency (RF) power transmission signals (e.g., the test power transmission signals and the additional power transmission signals are RF power transmission signals).

All of these examples are non-limiting and any number of combinations and multi-layered structures are possible using the example structures described above.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will also be understood that, although the terms “first,” “second,” etc. may be used herein to describe various elements, these elements should not be limited by these terms. These terms are only used to distinguish one element from another. For example, a first region could be termed a second region, and, similarly, a second region could be termed a first region, without changing the meaning of the description, so long as all occurrences of the “first region” are renamed consistently and all occurrences of the “second region” are renamed consistently. The first region and the second region are both regions, but they are not the same region.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. (canceled)

2. A method of operating a near-field wireless-power transmitter,
the near-field wireless-power transmitter including one or more processors, and a signature-signal-receiving circuit,
wherein the one or more processors of the near-field wireless-power transmitter are in communication with a data source that includes predefined signature signals,
wherein the predefined signature signals include predefined signature signals that correspond to each of a wireless power receiver, an object other than a wireless power receiver, and a combination of a wireless power receiver and an object other than a wireless power receiver, and
wherein the predefined signature signals comprise a combination of frequency and duty cycle values,
the method comprising:
transmitting a plurality of test power transmission signals,
wherein the test power transmission signals have first values for a set of transmission characteristics, and
wherein the set of transmission characteristics comprises a power level, a frequency, or a phase;
receiving a first amount of reflected power;
receiving a second amount of reflected power independently of receiving the first amount of reflected power;
in response to receiving the first and second respective amounts of reflected power, generating, using the signature-signal-receiving circuit, based on variations in the first and second respective amounts of reflected power, a first new signature signal and a second new signature signal;
determining, based, at least in part, on a comparison of the first new signature signal and the predefined signature signals, that a wireless power receiver is present within a near-field of the near-field wireless-power transmitter; and
in response to determining that a wireless power receiver is present within a near-field of the near-field wireless-power transmitter, transmitting power transmission signals having second values for the set of transmission characteristics to the wireless power receiver.

3. The method of claim 2 further comprising:
determining, based, at least in part, on a comparison of the second new signature signal and the predefined signature signals, that an object other than a wireless power receiver is present within a near-field of the near-field wireless-power transmitter; and
in response to determining that an object other than a wireless power receiver is present within a near-field of the near-field wireless-power transmitter, ceasing transmission of power transmission signals for a first threshold interval.

4. The method of claim 2 further comprising:
determining, based, at least in part, on a comparison of the first new signature signal, the second new signature signal, and the predefined signature signals, that a combination of a wireless power receiver and an object other than a wireless power receiver is present within the near-field of the near-field wireless-power transmitter;
in response to determining that a combination of a wireless power receiver and an object other than a wireless power receiver is present within the near-field of the near-field wireless-power transmitter, further determining whether the near-field wireless-power transmitter is configured to transmit wireless power while a combination of a wireless power receiver and an object other than a wireless power receiver is present on the near-field wireless-power transmitter; and
in response to determining that the near-field wireless-power transmitter is configured to transmit wireless power while the combination of the wireless power receiver and the object other than a wireless power receiver is present on the near-field wireless-power transmitter, transmitting power transmission signals having third values for the set of transmission characteristics to the wireless power receiver.

5. The method of claim 2, wherein the first amount of reflected power is received at a first power transmission zone of the near-field wireless-power transmitter.

6. The method of claim 2, wherein the second amount of reflected power is received at a second power transmission zone of the near-field wireless-power transmitter.

7. The method of claim 2, wherein the plurality of test power transmission signals is transmitted from the first power-transfer zone.

8. The method of claim 2, wherein a second test power transmission signal of the plurality of test transmission signals is transmitted upon expiration of a second threshold interval after transmission of a first test power transmission signal of the plurality of test transmission signals.

9. The method of claim 2, wherein the first and second values for the set of transmission characteristics are the same.

10. The method of claim 2, wherein the first and second values for the set of transmission characteristics are different.

11. A near-field wireless-power transmitter comprising a signature-signal-receiving circuit and one or more processors in communication with a data source that includes predefined signature signals corresponding to each of a wireless power receiver, an object other than a wireless power receiver, and a combination of a wireless power receiver and an object other than a wireless power receiver,
wherein the predefined signature signals comprise a combination of frequency and duty cycle values,
the near-field wireless-power transmitter caused to:
transmit a plurality of test power transmission signals having first values for a set of transmission characteristics,
wherein the set of transmission characteristics comprises a power level, a frequency, or a phase;
receive a first amount of reflected power;
receive a second amount of reflected power independently of receiving the first amount of reflected power;
in response to receiving the first and second respective amounts of reflected power, generate, using the signature-signal-receiving circuit, based on variations in the first and second respective amounts of reflected power, a first new signature signal and a second new signature signal;
determine, based, at least in part, on a comparison of the first new signature signal and the predefined signature signals, that a wireless power receiver is present within a near-field of the near-field wireless-power transmitter; and
in response to determining that a wireless power receiver is present within a near-field of the near-field wireless-power transmitter, transmit power transmission signals having second values for the set of transmission characteristics to the wireless power receiver.

12. The near-field wireless-power transmitter of claim 11 further caused to:
determine, based, at least in part, on a comparison of the second new signature signal and the predefined signature signals, that an object other than a wireless power receiver is present within a near-field of the near-field wireless-power transmitter; and
in response to determining that an object other than a wireless power receiver is present within a near-field of the near-field wireless-power transmitter, cease transmission of power transmission signals for a first threshold interval.

13. The near-field wireless-power transmitter of claim 11 further caused to:
determine, based, at least in part, on a comparison of the first new signature signal, the second new signature signal, and the predefined signature signals, that a combination of a wireless power receiver and an object other than a wireless power receiver is present within the near-field of the near-field wireless-power transmitter;
in response to determining that a combination of a wireless power receiver and an object other than a wireless power receiver is present within the near-field of the near-field wireless-power transmitter, further determine whether the near-field wireless-power transmitter is configured to transmit wireless power while a combination of a wireless power receiver and an object other than a wireless power receiver is present on the near-field wireless-power transmitter; and
in response to determining that the near-field wireless-power transmitter is configured to transmit wireless power while the combination of the wireless power receiver and the object other than a wireless power receiver is present on the near-field wireless-power transmitter, transmit power transmission signals having third values for the set of transmission characteristics to the wireless power receiver.

14. The near-field wireless-power transmitter of claim 11, wherein the first amount of reflected power is received at a first power transmission zone of the near-field wireless-power transmitter.

15. The near-field wireless-power transmitter of claim 11, wherein the second amount of reflected power is received at a second power transmission zone of the near-field wireless-power transmitter.

16. The near-field wireless-power transmitter of claim 11, wherein the plurality of test power transmission signals is transmitted from the first power-transfer zone.

17. The near-field wireless-power transmitter of claim 11, wherein a second test power transmission signal of the plurality of test transmission signals is transmitted upon expiration of a second threshold interval after transmission of a first test power transmission signal of the plurality of test transmission signals.

18. The near-field wireless-power transmitter of claim 11, wherein the first and second values for the set of transmission characteristics are the same.

19. The near-field wireless-power transmitter of claim 11, wherein the first and second values for the set of transmission characteristics are different.

20. A system of a near-field wireless-power transmitter comprising:
a signature-signal-receiving circuit;
one or more hardware processors in communication with a data source that includes predefined signature signals,
wherein the predefined signature signals include predefined signature signals that correspond to each of a wireless power receiver, an object other than a wireless power receiver, and a combination of a wireless power receiver and an object other than a wireless power receiver,
wherein the predefined signature signals comprise a combination of frequency and duty cycle values; and
at least one non-transitory memory storing instructions, which, when executed by the one or more hardware processors, cause the system to:
transmit a plurality of test power transmission signals having first values for a set of transmission characteristics,
wherein the set of transmission characteristics comprises a power level, a frequency, or a phase;
receive a first amount of reflected power;
receive a second amount of reflected power independently of receiving the first amount of reflected power;
in response to receiving the first and second respective amounts of reflected power, generate, using the signature-signal-receiving circuit, based on variations in the first and second respective amounts of reflected power, a first new signature signal and a second new signature signal;
determine, based, at least in part, on a comparison of the first new signature signal and the predefined signature signals, that a wireless power receiver is present within a near-field of the near-field wireless-power transmitter; and
in response to determining that a wireless power receiver is present within a near- field of the near-field wireless-power transmitter, transmit power transmission signals having second values for the set of transmission characteristics to the wireless power receiver.

21. The system of claim 20 further caused to:
determine, based, at least in part, on a comparison of the second new signature signal and the predefined signature signals, that an object other than a wireless power receiver is present within a near-field of the near-field wireless-power transmitter; and
in response to determining that an object other than a wireless power receiver is present within a near-field of the near-field wireless-power transmitter, cease transmission of power transmission signals for a first threshold interval.
